(19) United States
(12) Patent Application Publication
(10) Pub. No.: US 2024/0139067 A1
(43) Pub. Date: May 2, 2024

(54) Knee Osteoarthritis Treatment

(71) Applicant: Steve Fuhwa Chang, Bayside, NY (US)

(72) Inventor: Steve Fuhwa Chang, Bayside, NY (US)

(21) Appl. No.: 18/384,878

(22) Filed: Oct. 29, 2023

Related U.S. Application Data
(60) Provisional application No. 63/420,625, filed on Oct. 30, 2022.

(51) Int. Cl. A61H 39/08; A61H 99/00

(52) U.S. Cl. CPC A61H 39/086; A61H 99/00; A61H 2201/105; A61H 2205/102

(57) ABSTRACT

A knee osteoarthritis treatment, including: performing acupuncture on a first group of muscles associated with an osteoarthritic knee joint, including: Vastus Lateralis, Gluteus Maximus, Gluteus Medius, Semitendinosus, Semimembranosus, Biceps Femoris Long Head, Gastrocnemius Medial Head, Gastrocnemius Lateral Head, Biceps Femoris Short Head, Quadratus Lumborum, and Popliteus, and fascia associated with the osteoarthritic knee joint including: Iliotibial Tract; and performing deep tissue massage therapy on the first group of muscles, the fascia, and a second group of muscles associated with the osteoarthritic knee joint, including: Sartorius, Rectus Femoris, Psoas Major, and Gracilis. The knee osteoarthritis treatment may also include injecting Hyaluronic acid into a knee joint having osteoarthritic symptoms. Acupuncture of the present invention is performed by inserting one or more acupuncture needles into the muscle origin or the muscle insertion of the first group of muscles and the fascia for a period of time and later withdrawing the acupuncture needles.

This application claims the benefit of U.S. Provisional Application No. 63/420,625, filed Oct. 30, 2022, the full disclosure of which is incorporated herein by reference.

### BACKGROUND OF THE INVENTION

### Field of the Invention

The present invention relates generally to osteoarthritis treatment and more particularly to acupuncture knee osteoarthritis treatment.

### Background Art

Arthritis is a joint disease, which often includes swelling or tenderness of joints and typically worsens with age. Common arthritis symptoms include pain, swelling, stiffness, tenderness of joints, and decreased range of joint motion.

Although there are many types of arthritis, a common type of arthritis is osteoarthritis, which is a degenerative disease that worsens over time, and can affect almost any joint, but primarily affects the knees, hips, spine, and hands. Osteoarthritis occurs when cartilage, the hard, slippery tissue that covers the ends of bones where joints are formed, breaks down, which often results in chronic pain,

Knee osteoarthritis can affect an entire joint, including the knee joint capsule, cause deterioration of connective tissues that hold the joint together and attach muscle to bone, damage the bone, and cause inflammation of the joint lining. Knee osteoarthritis symptoms occur when the articular cartilage gradually deteriorates, and is the most common cause of disability in the United States.

Three bones meet and move against each other at the knee joint: the femur, also called the thigh bone; the tibia, also called the shin bone; and the patella, also called the kneecap, which is a moveable bone on the front of the knee, which glides along a femoral groove located at the bottom and front of the femur.

The underside of the patella is covered with articular cartilage, which is a smooth, slippery covering found on joint surfaces, that helps the patella glide (or track) in the femoral groove of the femur or thighbone.

The patella is wrapped inside a tendon that connects large muscles, called the quadriceps muscles, on the front of the thigh, to the tibia, which is the lower leg bone. The large quadriceps tendon, which is on top of the patella, together with the patella and the patellar tendon, which is below the patella, is called the quadriceps mechanism.

Tightening up the quadriceps muscles places a pull on the tendons of the quadriceps mechanism. This action causes the knee to straighten. The patella acts like a fulcrum to increase the force of the quadriceps muscles.

A key cause of knee osteoarthritis is degeneration of the articular cartilage, which is the smooth lining that covers the ends of the leg bones, where the leg bones form the knee joint. As previously mentioned, the articular cartilage gives the knee joint freedom of movement by decreasing friction. The layer of bone just below the articular cartilage is called subchondral bone.

When the articular cartilage degenerates or wears away, the bone underneath the articular cartilage is uncovered and rubs against bone or subchondral bone.

It should be noted that a key cause of articular cartilage degeneration is damage to the knee joint capsule, which has an inner synovial membrane, an outer layer of fibrous membrane, and is filled with synovial fluid. The synovial membrane is a delicate, thin membrane, which produces and retains synovial fluid that lubricates the knee joint. Synovial fluid cushions the ends of the femur and the tibia and reduces friction in the knee joint.

When pressure on or compression of the knee joint damages the synovial membrane, the synovial membrane may be prevented from producing an adequate amount of synovial fluid to lubricate and protect the knee joint. Once the volume of synovial fluid is reduced below a certain level and the articular cartilage is worn down substantially, the femur and the tibia rub against one another, and knee osteoarthritis begins.

Osteoarthritis of the knee often occurs when there is undue pressure on or compression on the knee joint capsule. Secretion of synovial fluid from the synovial membrane inside the knee joint capsule may decrease or be reduced, as a result of the undue pressure or compression, and the knee joint capsule may become damaged.

As a muscle contracts, the muscle pulls on a tendon, and the tendon moves the bone to which the tendon is attached.

Taut muscles are a key factor that cause increased pressure on or compression of the knee joint and, thus, damage the knee joint. A taut muscle, which may be under undue strain, may go into spasm, and cause a feeling that is often described as a “knot” in the muscle. The taut muscles, or tight muscles, not only put pressure on the knee joint, but push the femur and the tibia towards one another, forcing the ends of the femur and the tibia to rub against one another, diminish the ability of the synovial membrane to generate synovial fluid once the synovial membrane is damaged, and are a significant contributor to knee osteoarthritis.

Various forms of knee osteoarthritis treatments have been attempted, including surgical treatment, medication, cortisone injections, and knee replacement, among others, but an effective treatment, such as acupuncture alone or in combination with massage therapy is needed that slows or reverses progression of the disease, eases pain and swelling of the knee joint, and improves quality of life for those patients having osteoarthritic knee joints.

A process that facilitates and promotes osteoarthritic knee joints to heal naturally is necessary. In particular, a process for relieving taut muscles, muscle tightness, and undue pressure on the knee joint is necessary.

Different knee osteoarthritis treatments have heretofore been known. Attempts at treatment of knee osteoarthritis or improvement of osteoarthritis symptoms have focused on:
Weight loss to decrease knee pain from osteoarthritis;
Exercise to strengthen muscles around the knees to make knee joints more stable and decrease pain and stretching exercises to help keep the knee joint mobile and flexible;
Pain reliever and anti-inflammatory drugs to decrease inflammation of the joints and relieve pain;
Injections of corticosteroids, which are and anti-inflammatory drugs, into the knee;
Injections of hyaluronic acid into the knee.

However, none of these treatments have been totally effective.

U.S. Pat. No. 9,687,376 (Liu) discloses a knee brace having three stimulators for continuous electro-acupuncture stimulation, which comprises: a first circuit: having a first electrode configured to be electrically coupled to acupuncture point “Heting (S 156)” and a second electrode configured to be electrically coupled to acupuncture point “Bladder 40”; a second circuit having a third electrode configured to be electrically coupled to acupuncture point “Spleen 10” and a fourth electrode configured to be electrically coupled to acupuncture point “Hsiyen (S 145)”; and a third circuit having a fifth electrode configured to be electrically coupled to acupuncture point “Stomach 34” and a sixth electrode configured to be electrically coupled to acupuncture point “Stomach 35”. The first, third, and fifth electrodes are connected to a voltage, and the second, fourth, and sixth electrodes are connected to an opposite polarity of voltage, such that electric currents flow in a body of a patient to achieve analgesia, cartilage repair and regeneration of the knee joint.

U.S. Patent Application Publication Nos. US 2017/0072214 (Liu, et al.) and US 2018/0117353 (Liu, et al.) disclose a multi-frequency microwave acupuncture and moxibustion apparatus, having a microwave oscillator, amplifier, and radiator. Two types of operating frequencies are set: A at 433 MHz and B at 915 MHz. Output waveforms have continuous wave and four pulse modulation waves, respectively at 1 MHz, 5 MHz, 10 MHz, and 100 MHz, which are used to treat different symptoms.

U.S. Patent Application Publication No. US 20070265680 (Liu) discloses an electro-acupuncture stimulation system for in vivo and in situ analgesia and tissue repair and regeneration. Electrodes, which can be acupuncture needles, are percutaneously implanted that deliver a pulsed electrical current that creates an electrical field, which envelopes the targeted tissue and restores cell-generating homeostasis to the affected tissue and thereby promotes analgesia and tissue re-growth in otherwise debilitated or deteriorating tissue. Methods and apparatus are also disclosed that may include a needle locking system and acupuncture-needle assemblies for long-term in situ electrical stimulation.

There is thus a need for an effective treatment, such as acupuncture alone or in combination with massage therapy that slows or reverses progression of the disease, eases pain and swelling of the knee joint, heals the knee joint, and improves quality of life for those patients having osteoarthritic knee joints. The process should relieve taut muscles, relieve muscle strain, muscle tightness, and undue pressure on the knee joint is necessary, and facilitate the osteoarthritic knee joint to heal naturally. Treatment should slow or reverse progression of the disease, reduce swollen joints, and reduce pain.

### SUMMARY

The present invention is directed to a knee osteoarthritis treatment that uses acupuncture and massage therapy to slow and reverse progression of knee osteoarthritis, ease pain and swelling of osteoarthritic knee joints, heal inflamed knee joints naturally, and improve quality of life of those patients having osteoarthritic knee joints. The knee osteoarthritis treatment relieves taut muscles, muscle strain, muscle tightness, and undue pressure on knee joints and knee joint capsules, and facilitates and promotes osteoarthritic knee joints to heal naturally. The knee osteoarthritis treatment is effective in slowing and reversing progression of the disease, reducing swollen joints, reducing pain and inflammation, and improving the quality of life of those patients having osteoarthritic knee joints.

Acupuncture knee osteoarthritis treatment of the present invention is performed by inserting one or more acupuncture needles into the muscle origin or the muscle insertion of the first group of muscles and the fascia for a period of time and withdrawing the acupuncture needles after the period of time.

A knee osteoarthritis treatment having features of the present invention comprises:
performing acupuncture on a first group of muscles associated with an osteoarthritic knee joint at each muscle origin or each muscle insertion of the first group of muscles, comprising:
   Quadriceps muscles, comprising Vastus Lateralis;
   Gluteal muscles, comprising Gluteus Maximus, Gluteus Medius;
   Hamstring muscles, comprising Semitendinosus, Semimembranosus, Biceps Femoris Long Head, Biceps Femoris Short Head;
   Calf muscles, comprising Gastrocnemius Medial Head, Gastrocnemius Lateral Head;
   Quadratus Lumborum;
   Popliteus;
performing acupuncture on fascia associated with the osteoarthritic knee joint, comprising:
   Iliotibial Tract;
performing deep tissue massage on the first group of muscles associated with the osteoarthritic knee joint, comprising:
   the Quadriceps muscles, comprising the Vastus Lateralis;
   the Gluteal muscles, comprising the Gluteus Maximus, the Gluteus Medius;
   the Hamstring muscles, comprising the Semitendinosus, the Semimembranosus, the Biceps Femoris Long Head, the Biceps Femoris Short Head;
   the Calf muscles, comprising the Gastrocnemius Medial Head, the Gastrocnemius Lateral Head;
   the Quadratus Lumborum;
   the Popliteus;
performing deep tissue massage on the fascia associated with the osteoarthritic knee joint, comprising:
   the Iliotibial Tract; and
performing deep tissue massage on a second group of muscles associated with the osteoarthritic knee joint, comprising:
   Sartorius;
   the Quadriceps muscles, comprising Rectus Femoris;
   Psoas Major;
   Hip Adductors, comprising Gracilis.

A knee osteoarthritis treatment having features of the present invention may alternatively comprise:
performing acupuncture on a first group of muscles associated with an osteoarthritic knee joint at each muscle origin or each muscle insertion of the first group of muscles, comprising:
   Vastus Lateralis; Gluteus Maximus; Gluteus Medius; Semitendinosus; Semimembranosus; Biceps Femoris Long Head; Gastrocnemius Medial Head; Gastrocnemius Lateral Head; Biceps Femoris Short Head; Quadratus Lumborum; Popliteus;
performing acupuncture on fascia associated with the osteoarthritic knee joint, comprising:
   Iliotibial Tract;
performing deep tissue massage on the first group of muscles associated with the osteoarthritic knee joint, comprising:
   Vastus Lateralis; Iliotibial Tract; Gluteus Maximus; Gluteus Medius; Semitendinosus; Semimembranosus; Biceps Femoris Long Head; Gastrocnemius Medial Head; Gastrocnemius Lateral Head; Biceps Femoris Short Head; Quadratus Lumborum; Popliteus;
performing deep tissue massage on the fascia associated with the osteoarthritic knee joint, comprising:
   Iliotibial Tract; and
performing deep tissue massage on a second group of muscles associated with the osteoarthritic knee joint, comprising:
   Sartorius; Rectus Femoris; Psoas Major; Gracilis.

The knee osteoarthritis treatment may further comprise:
injecting hyaluronic acid into the osteoarthritic knee joint capsule.

### DRAWINGS

These and other features, aspects, and advantages of the present invention will become better understood with regard to the following description, appended claims, and accompanying drawings where:

FIG. 1 is a schematic representation of steps of a knee osteoarthritis treatment process of the present invention;

FIG. 2 is an anterior view of a human knee joint;

FIG. 3 is a lateral view of the human knee joint;

FIG. 4 is another anterior view of the human knee joint, showing a patella and femoral groove;

FIG. 4A is a lateral view of the human knee joint;

FIG. 5 is a lateral view of the human knee joint, showing a quadriceps mechanism;

FIG. 6 is a lateral view of human legs, showing the quadriceps mechanism, quadriceps tendon, and patellar tendon;

FIG. 6A is an anterior view of quadriceps muscles of the human leg;

FIG. 7 is an anterior view of the human knee joint, showing knee osteoarthritis;

FIG. 8 is an enlarged lateral view of a portion of the human knee joint, showing subchondral bone and articular cartilage;

FIG. 9 is a lateral view of the human knee joint, showing bursae of the knee joint;

FIG. 10 is a lateral view of the human knee joint, showing a synovial membrane of the knee joint;

FIG. 11 is a side view of the human knee joint, shown in the sagittal plane;

FIG. 12A is a frontal view of the human knee joint, shown in the coronal plane;

FIG. 12B is a frontal view of the human knee joint, shown in the coronal plane, showing an osteoarthritic knee joint;

FIG. 13 is a frontal view of the human knee joint, shown in the coronal plane, showing the structure of a knee joint capsule;

FIG. 14 is an anterior view of Quadriceps muscles of the human body;

FIG. 14A is an anterior view of a Vastus Lateralis muscle;

FIG. 14B is an anterior view of a Rectus Femoris muscle;

FIG. 15 is a posterior view of Gluteal muscles of the human body;

FIG. 15A is a posterior view of a Gluteus Maximus muscle;

FIG. 15B is a posterior view of a Gluteus Medius muscle;

FIG. 16 is a posterior view of Hamstring muscles of the human body;

FIG. 16A is a posterior view of a portion of a human leg showing a Semitendinosus muscle and location and direction of acupuncture needles;

FIG. 16B is a posterior view of a portion of a human leg showing a Semimembranosus muscle and location and direction of acupuncture needles;

FIG. 16C is a posterior view of a portion of a human leg showing a Biceps Femoris Long Head of a Biceps Femoris muscle and location and direction of acupuncture needles;

FIG. 16D is a posterior view of a portion of a human leg showing a Biceps Femoris Short Head of a Biceps Femoris muscle and location and direction of acupuncture needles;

FIG. 17 is a posterior view of Calf muscles of the human body;

FIG. 17A is a posterior view of a Gastrocnemius Medial Head of a Gastrocnemius muscle and location and direction of acupuncture needles;

FIG. 17B is a posterior view of a Gastrocnemius Lateral Head of a Gastrocnemius muscle and location and direction of acupuncture needles;

FIG. 17C is a posterior view of quadratus lumborum muscle anatomy, a Quadratus Lumborum muscle, lumbar spine, and location and direction of acupuncture needles;

FIG. 17D is a posterior view of a portion of a human leg showing a Popliteus muscle and location and direction of acupuncture needles;

FIG. 18 is an anterior view of a portion of a human leg showing an Iliotibial Tract fascia;

FIG. 19 is an anterior view of a human body muscular system;

FIG. 20 is an anterior view of a portion of a human leg showing a Sartorius muscle;

FIG. 21 is an anterior view of a human body skeletal system, showing a Psoas Major muscle;

FIG. 22 is an anterior view of a Psoas Major muscle anatomy;

FIG. 23 is an anterior view of Thigh muscles of the human body;

FIG. 24A is an anterior view of Hip Adductor muscle anatomy of the human body;

FIG. 24B is a posterior view of Hip Adductor muscle anatomy of the human body;

FIG. 25 is a posterior view of the human body skeletal system, also showing the Gracilis muscle of the muscular system;

FIG. 26 is a posterior view of a the Gracilis muscle;

FIG. 27 is a posterior view of the human body muscular system;

FIG. 28 is a posterior view of the human body skeletal system, also showing muscles of the muscular system; and

FIG. 29 is a front view of acupuncture needles used in the knee osteoarthritis treatment of the present invention.

### DESCRIPTION

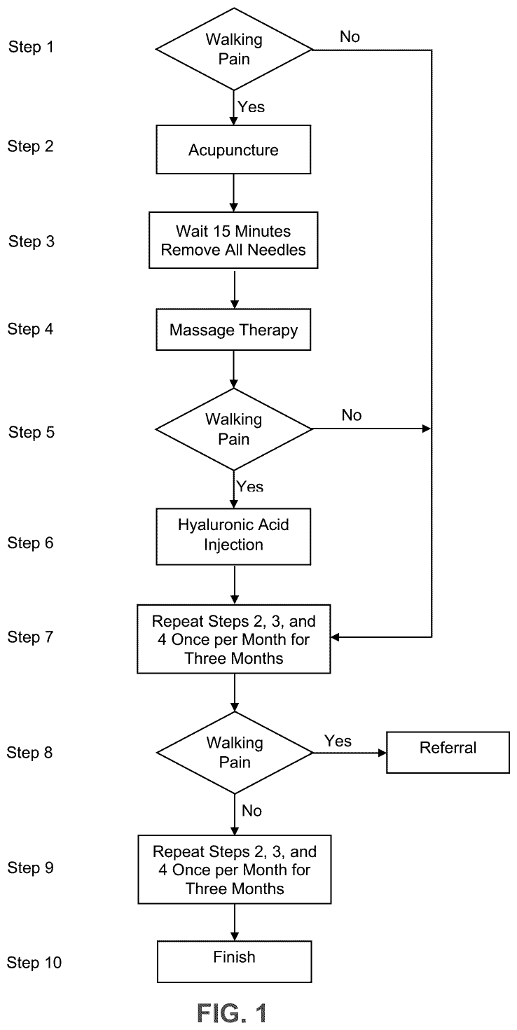

The preferred embodiments of the present invention will be described with reference to FIGS. 1-29 of the drawings. Identical elements in the various figures are identified with the same reference numbers.

FIG. 1 shows steps of a knee osteoarthritis treatment process of the present invention, including: acupuncture at a muscle's origin and/or a muscle's insertion; massage therapy; and hyaluronic acid injections.

The knee osteoarthritis treatment process of FIG. 1 comprises the steps of:
(1) determining if a patient has knee osteoarthritis symptoms;
   (1A) if the patient does not have knee walking pain symptoms:
      performing step (7);
   (1B) if the patient has knee osteoarthritis:
      (2) performing acupuncture on a first group of muscles and fascia associated with the osteoarthritic knee joint for a period of time by inserting acupuncture needles at the origin or the insertion of selected muscles and by inserting acupuncture needles into selected fascia;
      (3) removing the acupuncture needles from the origin or the insertion of the selected muscles and the selected fascia after the period of time;
      (4) performing deep tissue massage therapy on the first group of muscles, the selected fascia, and a second group of muscles associated with the osteoarthritic knee joint;
(5) determining if the patient has walking pain;
   (5A) if the patient does not have walking pain:
      performing step (7);
   (5B) if the patient has walking pain:
      (6) referring the patient for other treatment, including possible injections of hyaluronic acid into the knee joint(s);
(7) continuing from Step 1A or Step 5A, repeating steps (2), (3), and (4) periodically;
(8) determining if the patient has walking pain;
   (8A) if the patient has walking pain:
      (6) referring the patient for other treatment, including possible injections of hyaluronic acid into the knee joint(s);
   (8B) if the patient does not have walking pain:
   (9) repeating steps (2), (3), and (4) periodically.

Upon evaluating the patient's condition and determining if the patient has knee osteoarthritis and if the patient has knee osteoarthritis, then, a course of treatment is established.

Step (1), determining if a patient has knee osteoarthritis symptoms, comprises:
evaluating the patient's condition and determining if the patient has:
   pain at one or both knee joints, particularly during or after movement;
   joint stiffness upon awakening or after being inactive;
   tenderness in the area of the knee joint;
   loss of flexibility at the knee joint;
   grating sensation at the knee joint;
   bone spurs at the knee joint;
   swelling at the knee joint; or
   had medical diagnosis.

Steps (2), (3), and (4) are preferably repeated periodically at intervals of once per week for three months, although other suitable intervals and time frames may be used.

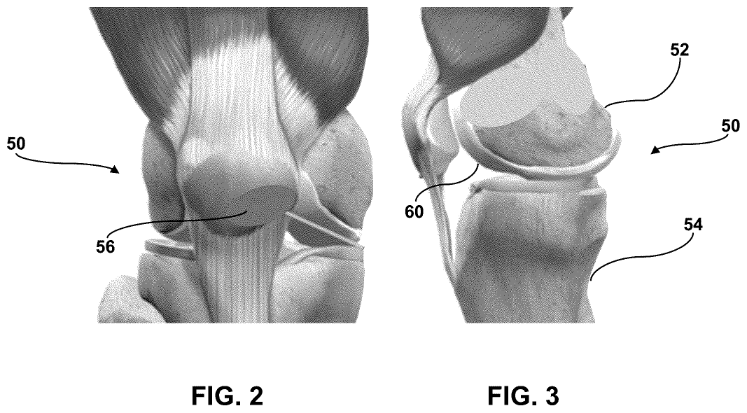

FIGS. 2-10 show the anatomy of a typical human knee joint 50 and the working relationship of the knee joint 50 and its components to be treated at step (2) of the knee osteoarthritis treatment process of the present invention of FIG. 1.

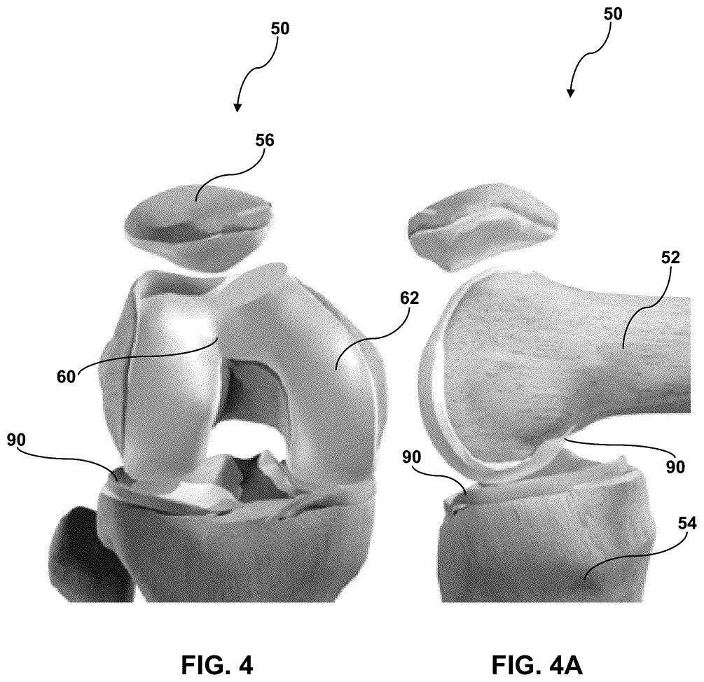

FIGS. 2 and 3 show the anatomy of a typical human knee joint 50 and the relationship of femur 52, tibia 54, patella 56, and femoral groove 60. Three bones meet and move against each other at the knee joint 50: the femur 52, also called the thigh bone; the tibia 54, also called the shin bone; and the patella 56, also called the kneecap, which is a moveable bone on the front of the knee. The patella 56 (kneecap) glides along the femoral groove 60, which is located along the bottom to the front of the femur 52, as shown in FIGS. 4 and 4A.

Articular cartilage is an extremely slippery, strong, flexible material found on joint surfaces that covers the surfaces of the bones where they meet at the bottom of the femur, the top of the tibia, and the back of the kneecap. Articular cartilage 90 is shown in FIGS. 4 and 4A at the top of the tibia 54, which helps the patella 56 glide (or track) in the femoral groove 60 of the femur 52 or thighbone, as shown in FIGS. 4 and 4A.

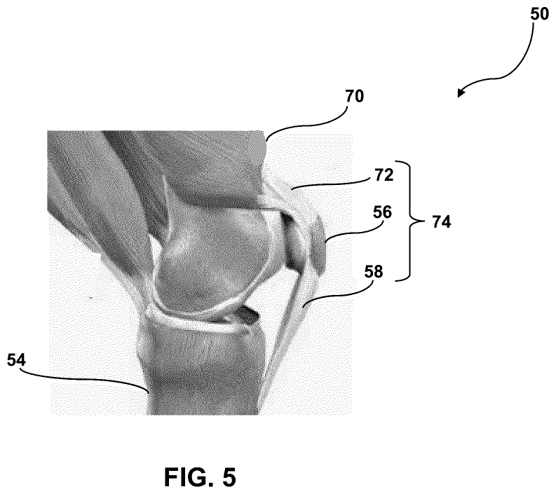

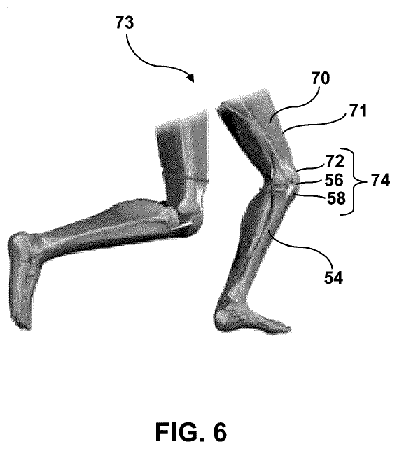

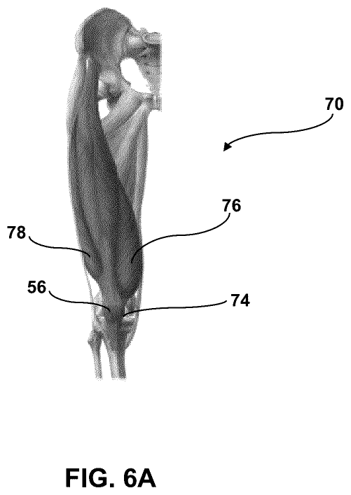

The patella 56 is wrapped inside the quadriceps tendon 72 and the patella tendon 58 that connects large muscles, called the quadriceps muscles 70, on the front of the thigh 71, to the tibia 54, which is the lower leg bone. The large quadriceps tendon 72, which is on top of the patella 56, together with the patella 56 and the patellar tendon 58, which is below the patella 56, is called the quadriceps mechanism 74 of the human legs 73, as shown in FIGS. 5 and 6.

Tightening up the quadriceps muscles 70 places a pull on the tendons of the quadriceps mechanism 74. This action causes the knee or knee joint 50 to straighten. The patella 56 acts like a fulcrum to increase the force of the quadriceps muscles 70. The quadriceps muscles 70 are also shown in FIG. 6A.

Two of the quadriceps muscles 70 of the thigh 71, the vastus medialis obliquus 76 (VMO) and the vastus lateralis 78 (VL), attach to the patella 56 and help control the patella's 56 position in the femoral groove 60 as the leg 73 straightens. The vastus medialis obliquus 76 (VMO) runs along the inside of the thigh 71, and the vastus lateralis 78 (VL) lies along the outside of the thigh 71, as shown in FIG. 6A.

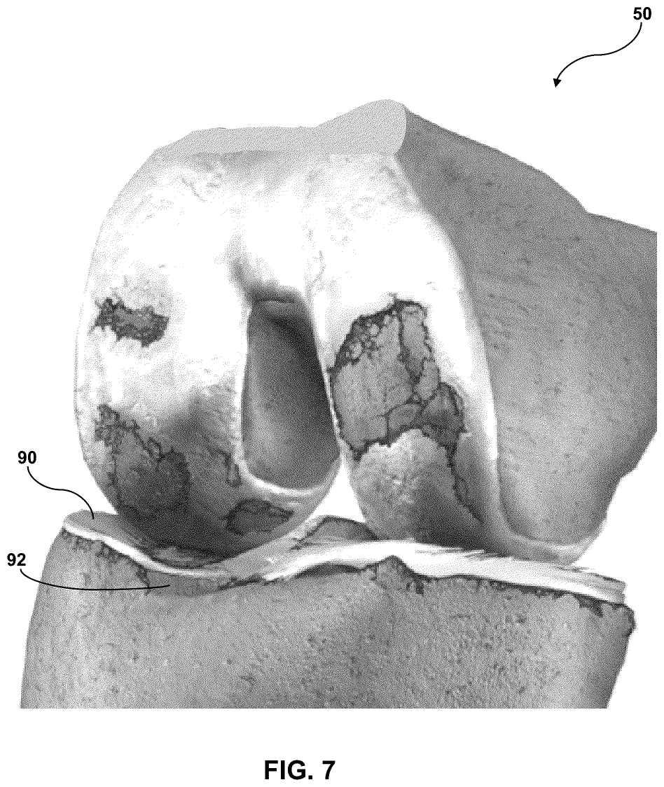

A key cause of knee osteoarthritis is degeneration of the articular cartilage 90, which is the smooth lining that covers the ends of the leg bones, where the leg bones form the knee joint 50, as shown in FIG. 7. As previously mentioned, the articular cartilage 90 gives the knee joint 50 freedom of movement by decreasing friction. The layer of bone just below the articular cartilage 90 is called subchondral bone 92.

When the articular cartilage 90 degenerates or wears away, subchondral bone 92, which is the bone underneath the articular cartilage 90, degenerates and becomes worn and/or warn away, as shown in FIG. 7.

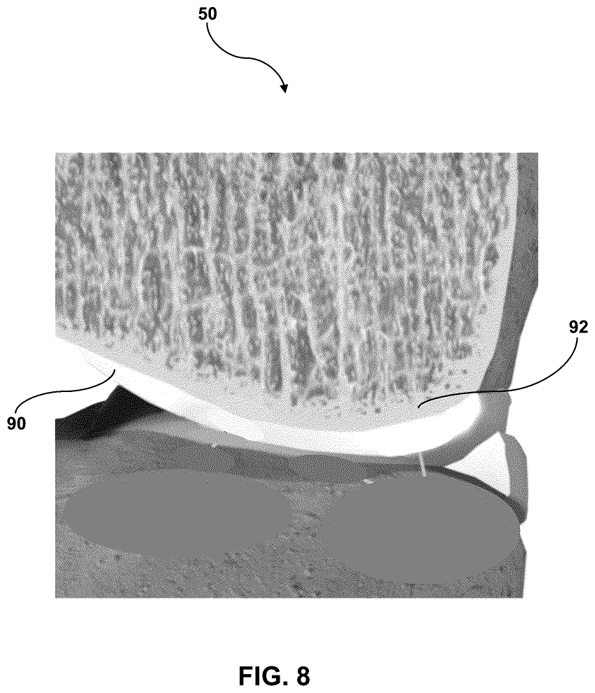

FIG. 8 shows an enlarged view of a portion of the human knee joint 50, showing subchondral bone 92 and the articular cartilage 90.

Various forms of knee osteoarthritis treatments have been attempted, including surgical treatment, medication, cortisone injections, and knee replacement, among others, but an effective holistic treatment, such as acupuncture alone or in combination with other holistic treatments, is needed that eases pain and swelling in the knee joint and allows cartilage to be replaced or supplemented with an alternative means for the patella 56 to easily glide along the femoral groove 60.

Tendons, ligaments, muscles, and skin must glide over bones during joint movement. Tiny, slippery sacs of fluid called bursae facilitate this gliding motion, by providing a thin cushion and reducing friction between the surfaces.

A bursa is a tiny, slippery, fluid-filled sac located between a bone and soft tissue. Like cartilage, bursae reduce friction. While cartilage reduces friction between bones, bursae reduce friction between bones and soft tissues, such as muscles and tendons. The bursae help muscles and tendons slide freely, as the knee joints move. The knee has several bursae.

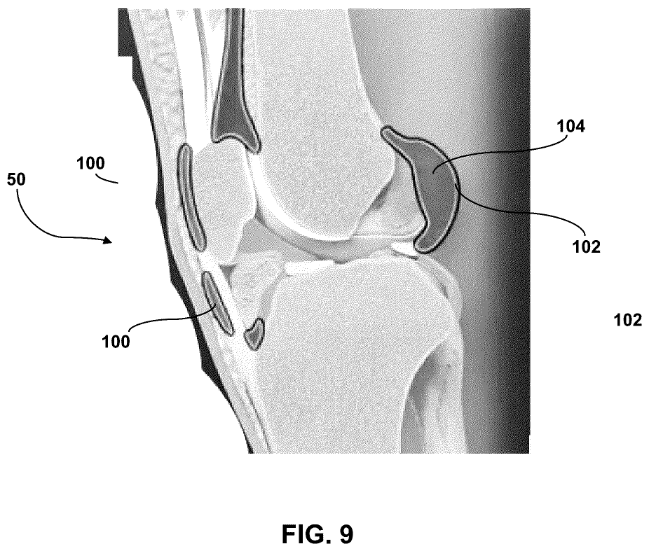

Knee bursae 100, which are shown in FIG. 9, are fluid-filled sacs, each one of which is like a miniature water balloon with only a few drops of fluid in it, wedged between bone and soft tissue that reduce friction between moving parts in the knee's joints. FIG. 9 also shows a synovial membrane 102 and synovial fluid 104.

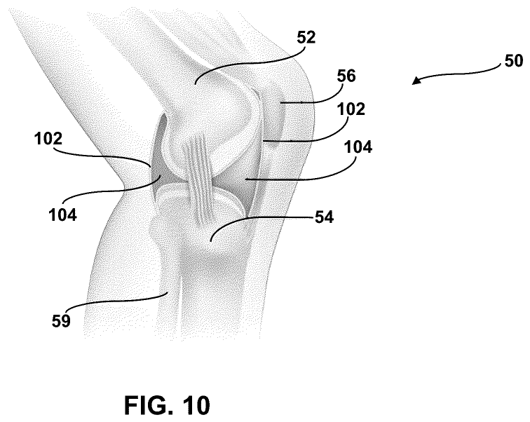

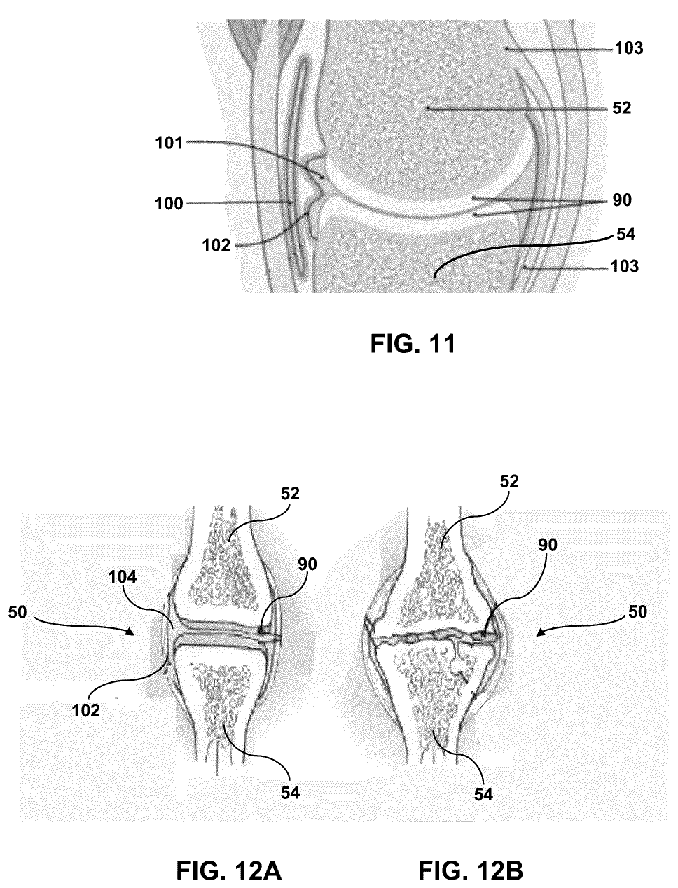

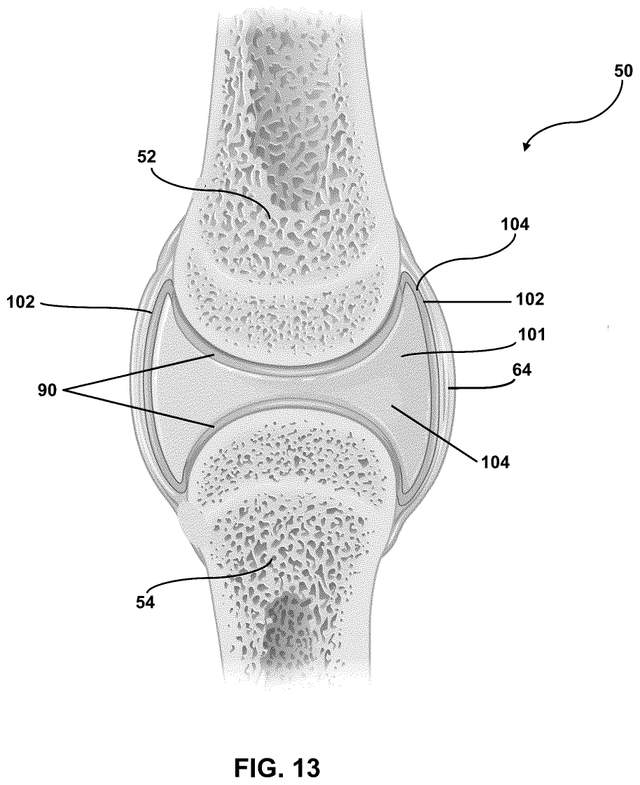

FIGS. 9 and 10 show synovial membrane 102 that encapsulates the knee joint 50, and is a thin, delicate membrane that produces synovial fluid 104, lubricates the knee joint 50, and circulates nutrients to the knee joint 50. The synovial membrane 102 produces the synovial fluid 104, which is a viscous fluid that lubricates the knee joint 50 that surrounds and communicates with the synovial cavity 101, shown in FIGS. 11 and 13, which is also called knee joint cavity.

FIGS. 11-13 show the human knee joint in more detail. FIG. 11 shows a side view of the human knee joint 50 in the sagittal plane; FIG. 12A shows a frontal view of the human knee joint 50 in the coronal plane; FIG. 12B shows a frontal view of the human knee joint 50, in the coronal plane, showing an osteoarthritic knee joint; and FIG. 13 shows a frontal view of the human knee joint 50 in the coronal plane, showing the structure of a knee joint capsule 64.

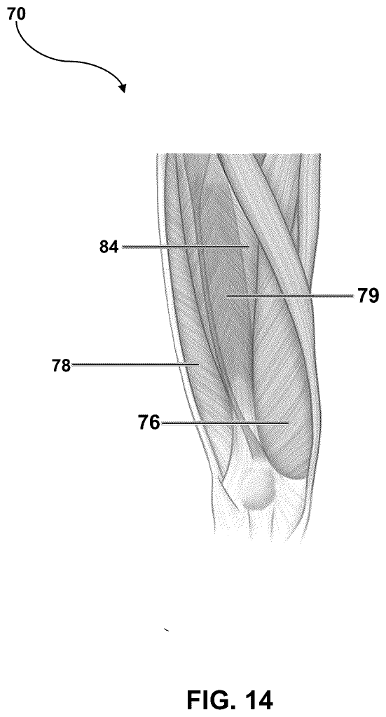

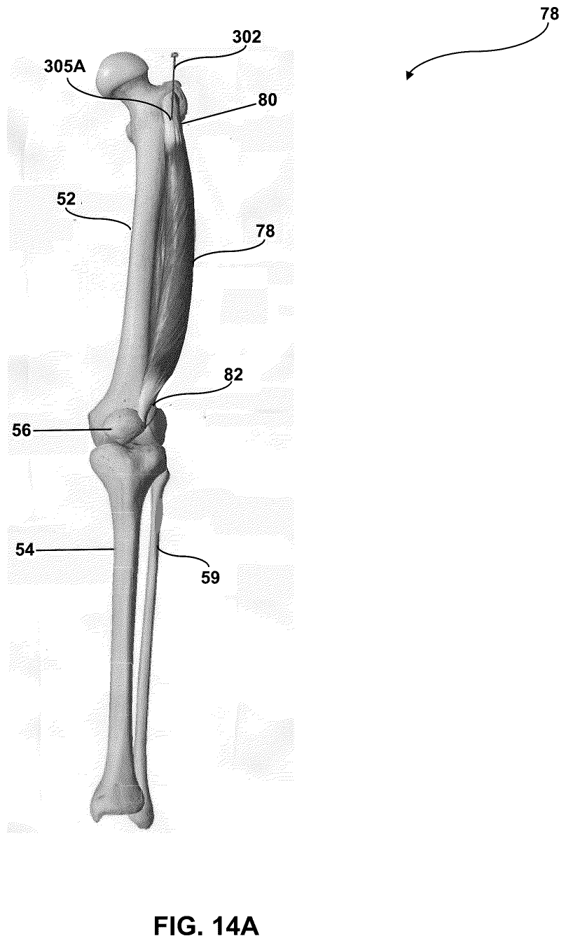

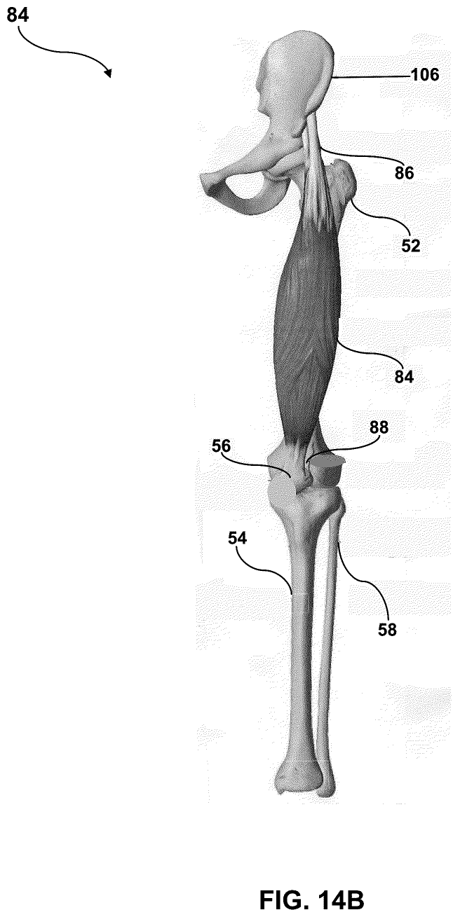

In more detail, the structure of a human knee joint 50 includes the femur 52, the upper part of the knee joint 50; the tibia 54 and the fibula 59, which is the lower part of the knee joint, shown in FIG. 14A, the patella 56, at the front of the knee joint 50; and connective tissue of the knee joint capsule 64, which connects and wraps the femur 52 and the tibia 54 and has a synovial cavity 101, which contains synovial fluid 102. Knee enthesis 103, which are the sites where tendons or ligaments insert into bones are also shown.

The knee joint capsule 64 has an outer layer of fibrous membrane, which keeps the femur 52 and the tibia 54 together structurally, and an inner layer, the synovial membrane 102, which produces and retains the synovial fluid 102. Synovial fluid 102 cushions the ends of the femur 52 and the tibia 54 and reduces friction in the knee joint 50.

Osteoarthritis of the knee often occurs when there is undue pressure on or compression of the knee joint capsule 64. The knee joint capsule 64 or synovial membrane 102 may become damaged and the articular cartilage 90 may become damaged, as a result of the undue pressure or compression.

When pressure on or compression of the knee joint damages the synovial membrane 102, the synovial membrane 102 may be prevented from producing an adequate amount of synovial fluid 102 from the knee joint capsule 64 to lubricate and protect the knee joint. Once the volume of synovial fluid 102 is reduced below a certain level and the articular cartilage 90 is worn down substantially, the femur and the tibia rub against one another, and knee osteoarthritis knee begins.

Taut muscles are a key factor that causes increased pressure on or compression of the knee joint 50 and, thus, damage to the knee joint. A taut muscle may go into spasm, and cause a feeling is often described as a “knot” in the muscle. The taut muscles not only put pressure on the knee joint, but push the femur and the tibia towards one another, forcing the ends of the femur and the tibia to rub against one another, and are a significant contributor to knee osteoarthritis.

The knee osteoarthritis treatment of the present invention reduces pressure on the knee joint capsule 64, using acupuncture and massage therapy to relax muscles that induce pressure on the knee joint capsule 64 of the osteoarthritis knee joint.

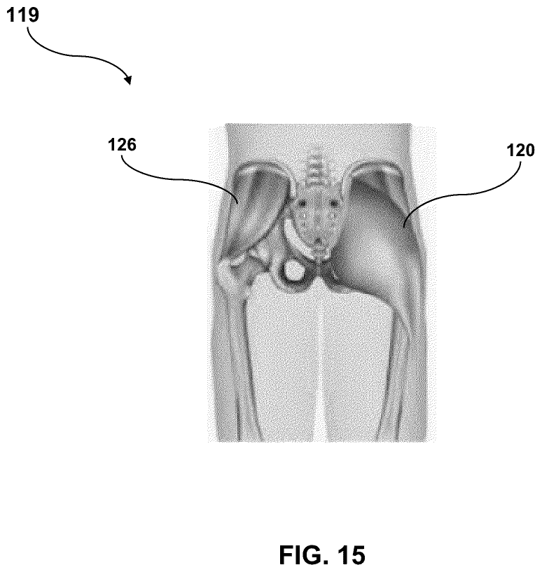

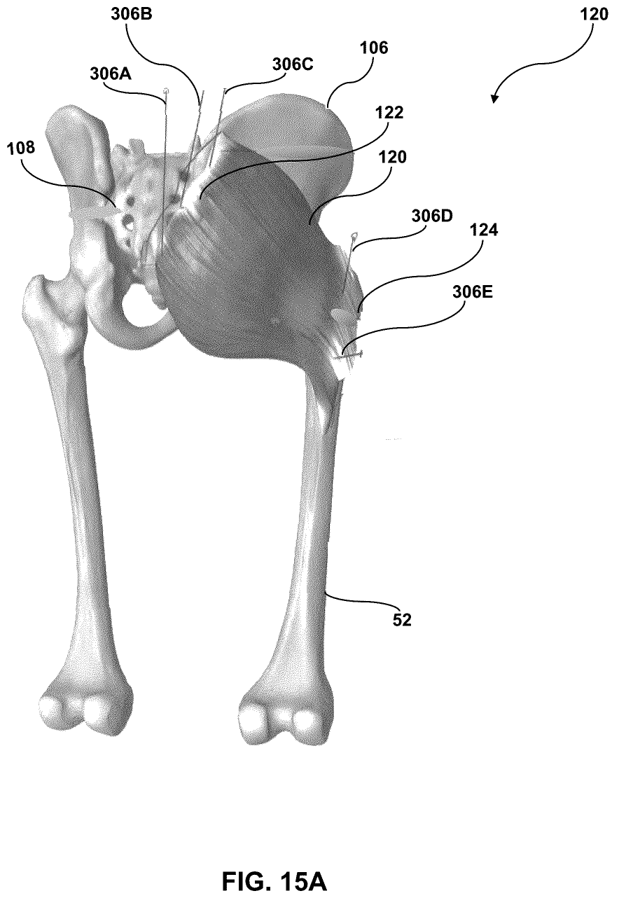

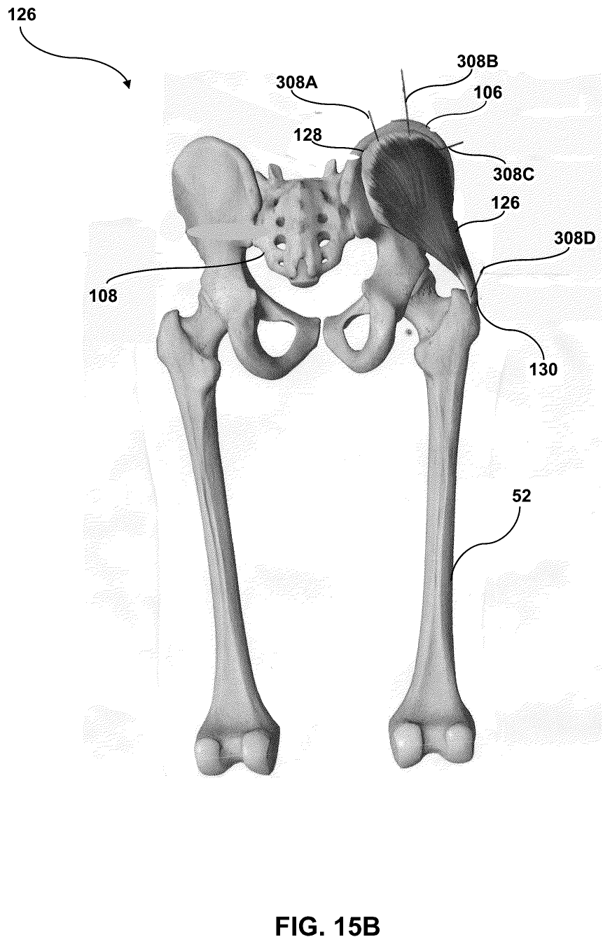

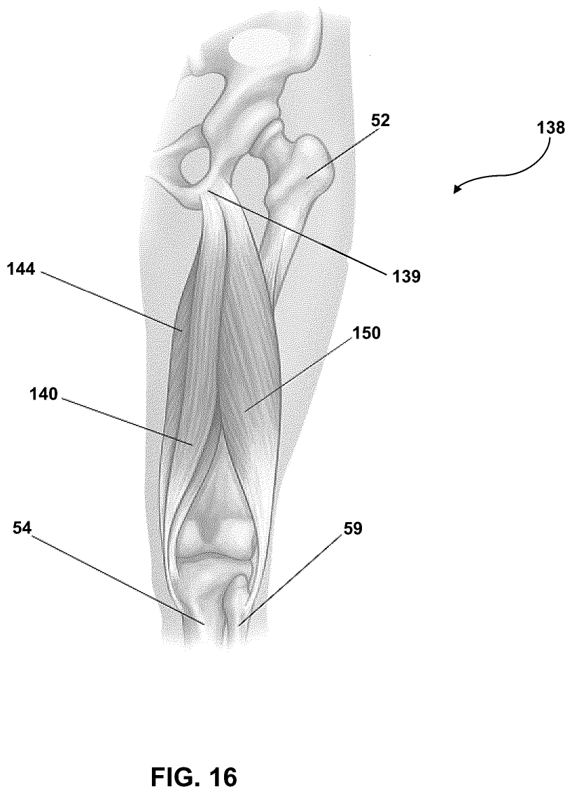

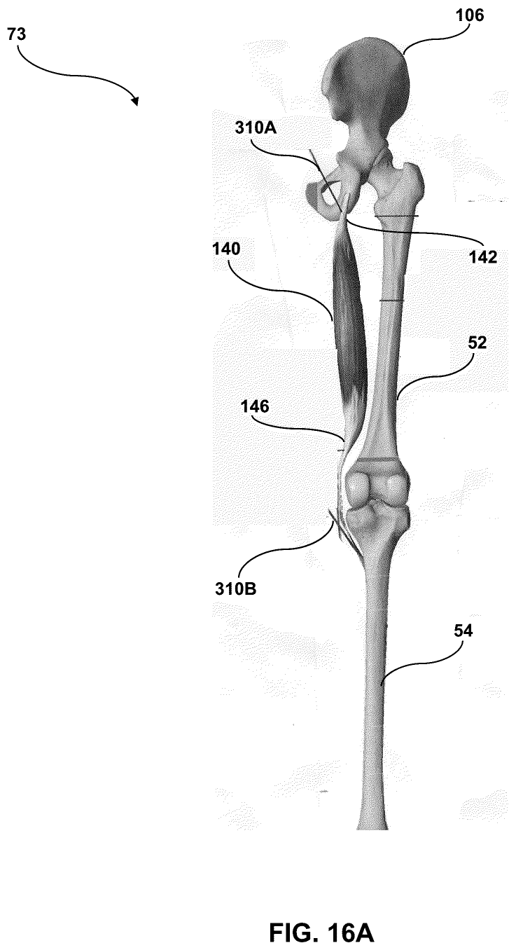

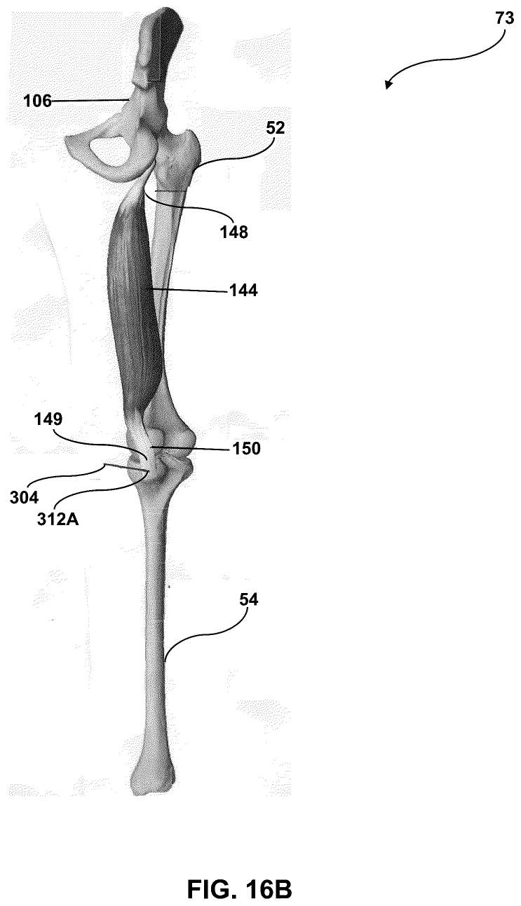

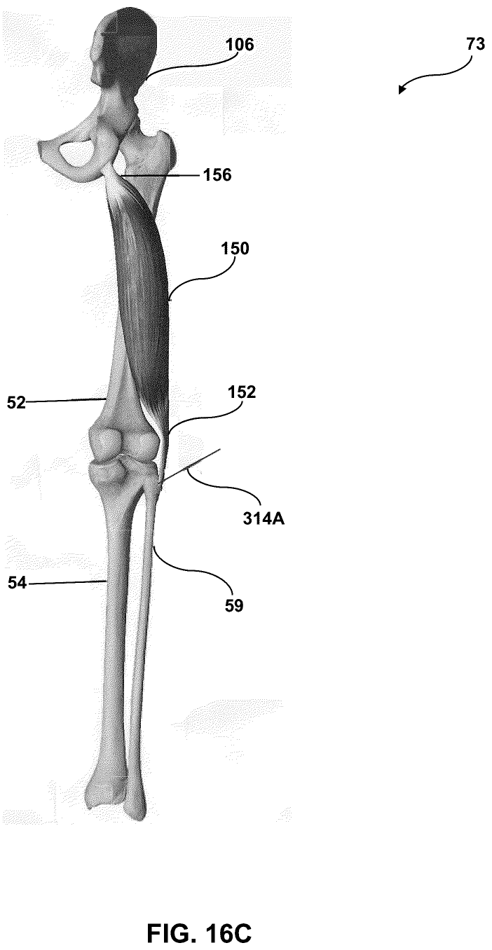

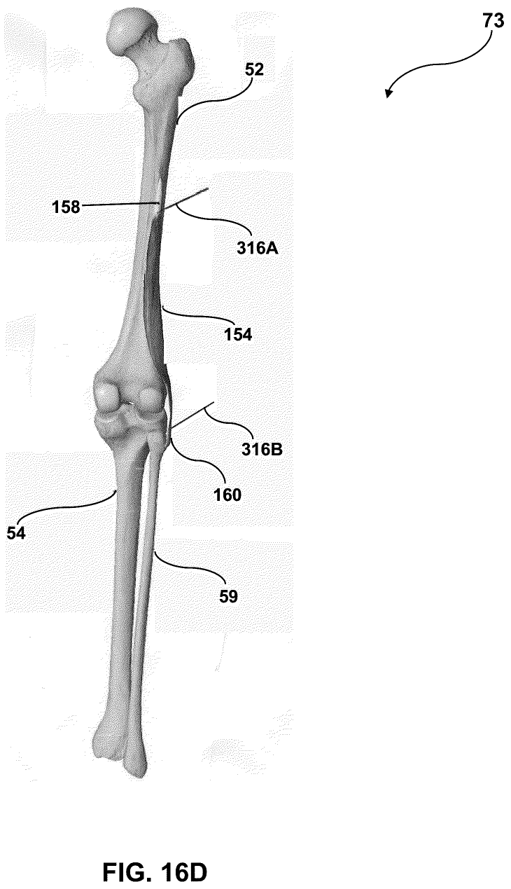

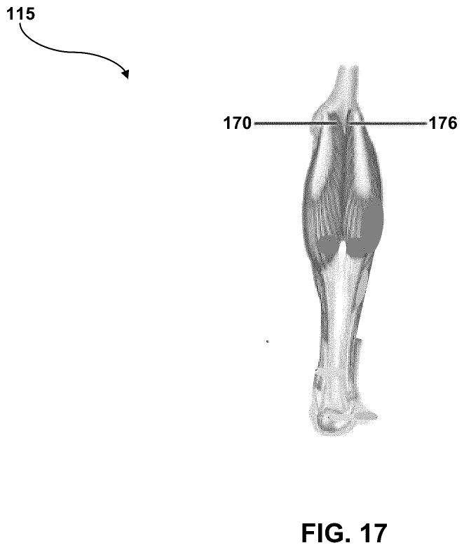

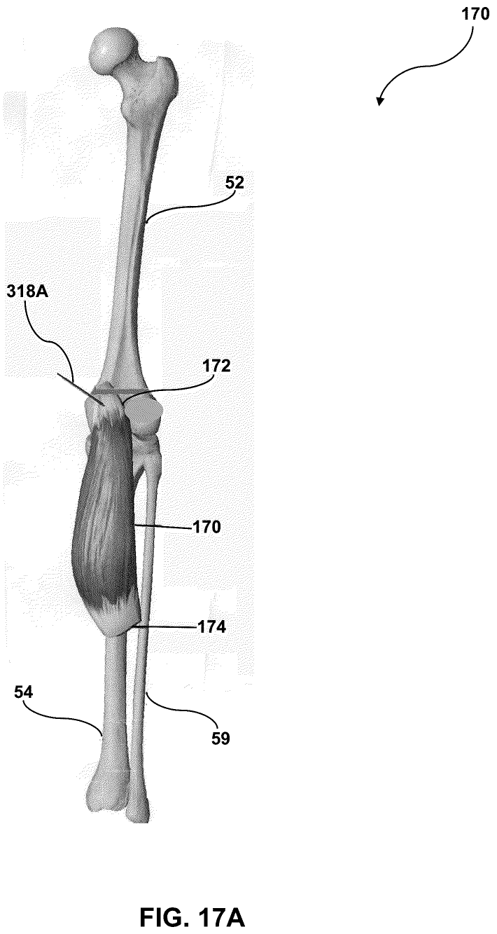

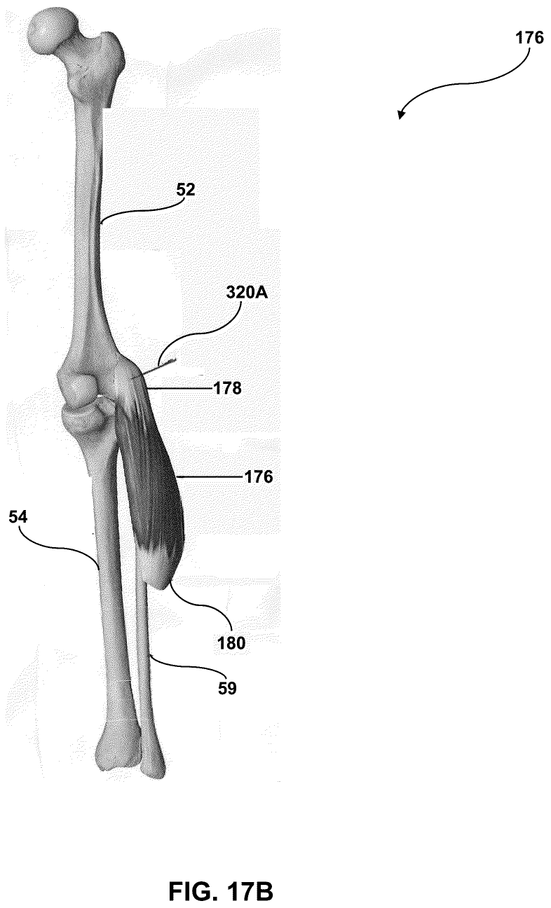

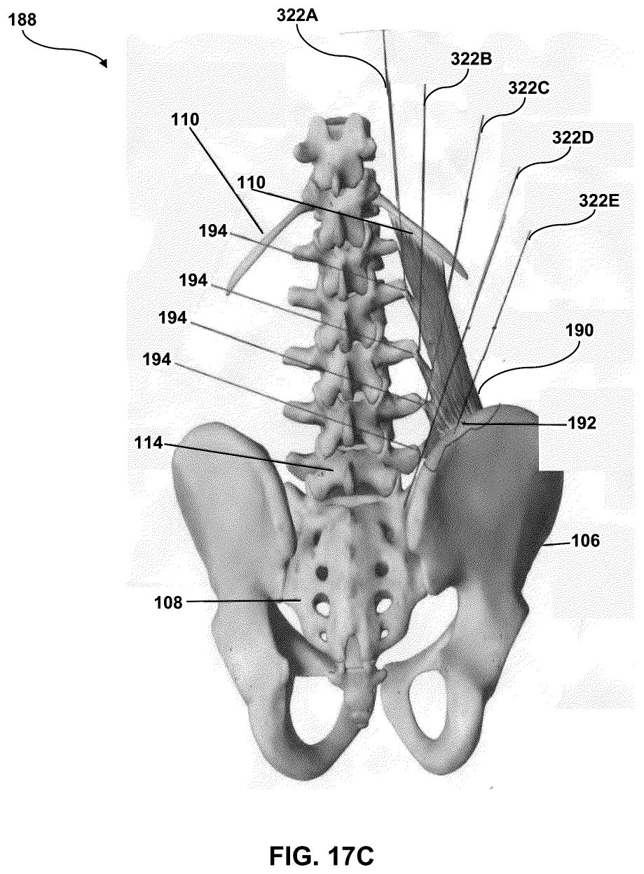

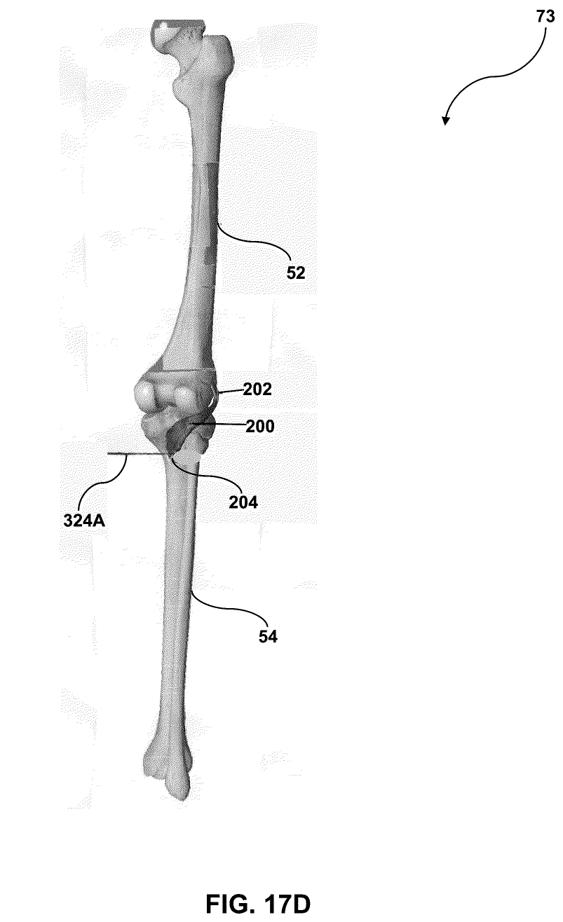

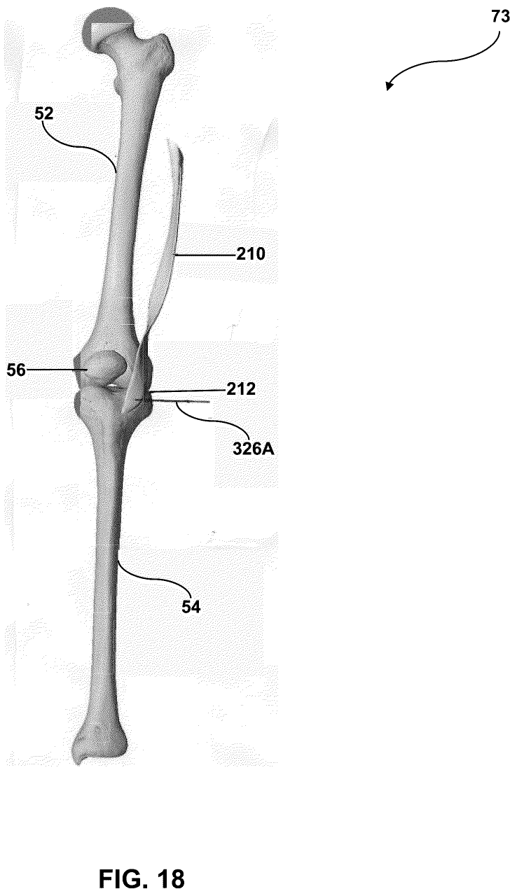

Now, continuing with FIG. 1, if the patient has knee osteoarthritis, then step (2) comprises:
performing acupuncture on a first group of muscles associated with an osteoarthritic knee joint at each muscle origin or each muscle insertion of the first group of muscles, comprising:
   Quadriceps muscles 70, shown in FIG. 14, comprising Vastus Lateralis 78;
   Gluteal muscles 119, shown in FIG. 15, comprising Gluteus Maximus 120, Gluteus Medius 126;
   Hamstring muscles 138, shown in FIG. 16, comprising Semitendinosus 140, Semimembranosus 144, Biceps Femoris Long Head 150, Biceps Femoris Short Head 154;
   Calf muscles 115, shown in FIG. 17, comprising Gastrocnemius Medial Head 170, Gastrocnemius Lateral Head 176;
   Quadratus Lumborum 190, shown in FIG. 17C;
   Popliteus 200, shown in FIG. 17D;
performing acupuncture on fascia associated with the osteoarthritic knee joint, comprising:
   Iliotibial Tract 210, shown in FIG. 18.

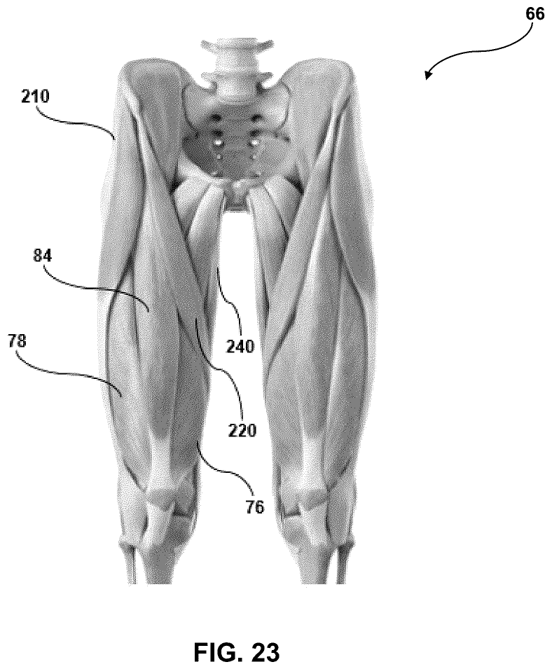

Alternatively, if the patient has knee osteoarthritis, step (2) may comprise:
performing acupuncture on a first group of muscles associated with the osteoarthritic knee joint, using acupuncture needles at the origin or the insertion of the following muscles:
   Vastus Lateralis 78, which is shown in FIGS. 14A and 23;
   Gluteus Maximus 120, which is shown in FIG. 15A;
   Gluteus Medius 126, which is shown in FIG. 15B;
   Semitendinosus 140, which is shown in FIGS. 16 and 16A;
   Semimembranosus 144, which is shown in FIGS. 16 and 16B;
   Biceps Femoris Long Head 150, which is shown in FIGS. 16 and 16C;
   Gastrocnemius Medial Head 170, which is shown in FIG. 17A;
   Gastrocnemius Lateral Head 176, which is shown in FIG. 17B;
   Biceps Femoris Short Head 154, which is shown in FIGS. 16 and 16D;
   Quadratus Lumborum 190, which is shown in FIG. 17C; and
   Popliteus 200, which is shown in FIG. 17D.
performing acupuncture on fascia associated with the osteoarthritic knee joint, comprising:
   Iliotibial Tract 210, which is shown in FIGS. 18 and 23.

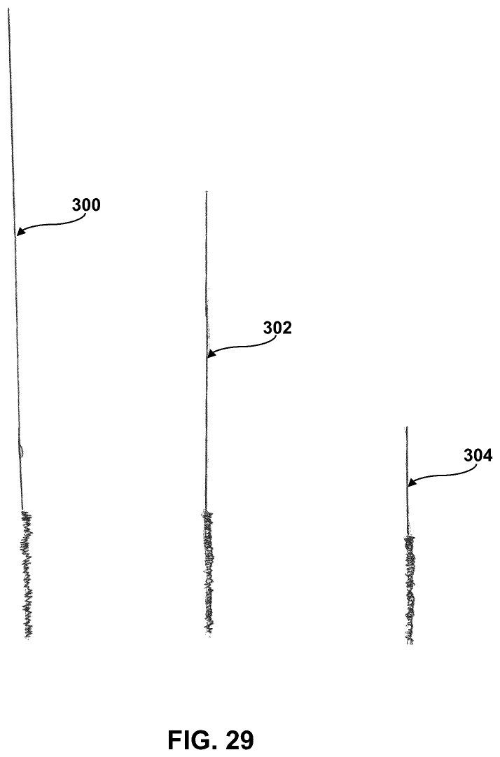

FIG. 29 is a front view of acupuncture needles used in the knee osteoarthritis treatment of the present invention.

The acupuncture of step (2) is performed using acupuncture needles 300, 302, and 304, which are shown in FIG. 29, and selected based upon the patient's body size and needling locations.

One or more sizes of the acupuncture needles 300, 302, and 304 or other suitable sizes and types of acupuncture needles may be inserted into the origin or the insertion of the above referenced muscles and the fascia in an oblique direction or a perpendicular direction to the muscles and the selected facia to provide efficacy and minimize danger to the patient.

The patient is typically positioned in a prone position, and the acupuncture needles 300, 302, and 304 are typically applied at the appropriate muscle origins and/or muscle insertions, depending on the condition and needs of the patient.

The acupuncture needles 300, 302, and 304, shown in FIG. 29, are designated as (#30G×6.0″), (#30G×3.0″) or (#30G×1.0″) 300, 302, and 304, respectively, although other suitable acupuncture needles may be used.

Again, the sizes of the acupuncture needles are selected, based upon the patient's body size and the acupuncture needling locations. Three inch long needles 302 and one inch long needles 304 are typically used; however, other suitable acupuncture needle sizes and types may be used.

The acupuncture treatment of the osteoarthritic knee joint may be performed for a period of fifteen minutes or another suitable period of time, depending upon the needs of the patient.

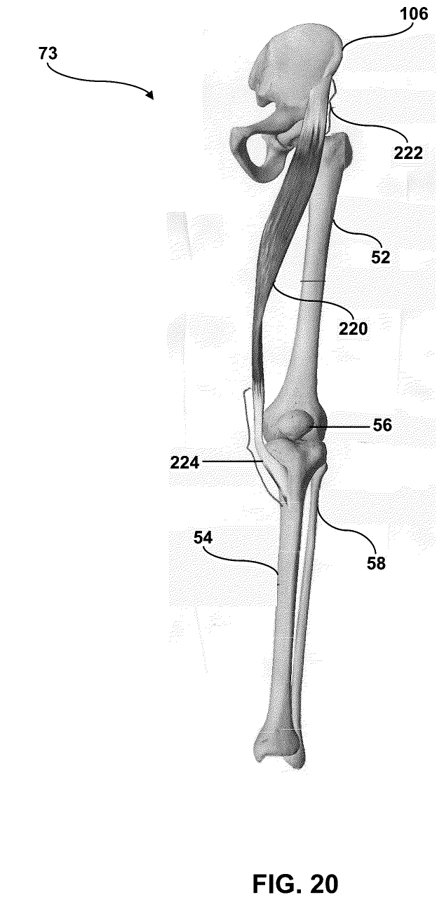

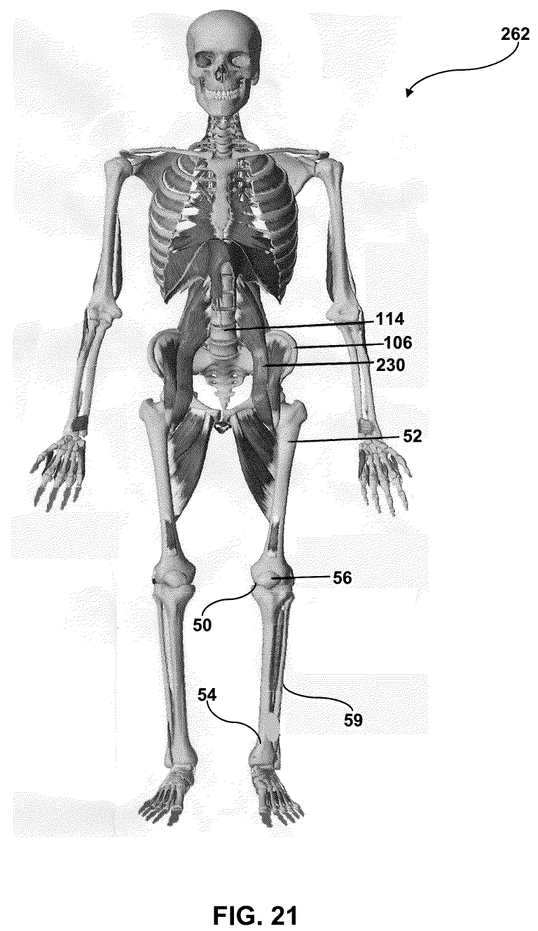

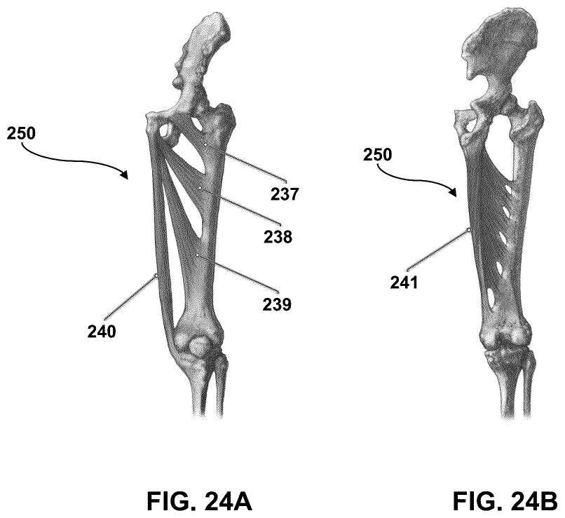

Now, continuing with FIG. 1, if the patient has knee osteoarthritis, then continuing with step (4), comprises:
performing deep tissue massage on the first group of muscles associated with the osteoarthritic knee joint, comprising:
   the Quadriceps muscles, shown in FIG. 14, comprising the Vastus Lateralis 78, and the Vastus Medialis 76;
   the Gluteal muscles 119, shown in FIG. 15, comprising the Gluteus Maximus 120, the Gluteus Medius 126;
   the Hamstring muscles 138, shown in FIG. 16, comprising the Semitendinosus 140, the Semimembranosus 144, the Biceps Femoris Long Head 150, the Biceps Femoris Short Head 154;
   the Calf muscles 115, shown in FIG. 17, comprising the Gastrocnemius Medial Head 170, the Gastrocnemius Lateral Head 176;
   the Quadratus Lumborum 190, shown in FIG. 17C;
   the Popliteus 200, shown in FIG. 17D;
performing deep tissue massage on the fascia associated with the osteoarthritic knee joint, comprising:
   the Iliotibial Tract 210, shown in FIG. 18; and
performing deep tissue massage on a second group of muscles associated with the osteoarthritic knee joint, comprising:
   Sartorius 220, shown in FIG. 20;
   the Quadriceps muscles 70, comprising Rectus Femoris 84, shown in FIG. 14;
   Psoas Major 230, shown in FIG. 21;
   Hip Adductors 250, shown in FIGS. 23 and 24A, comprising Gracilis 240, and FIG. 24B.

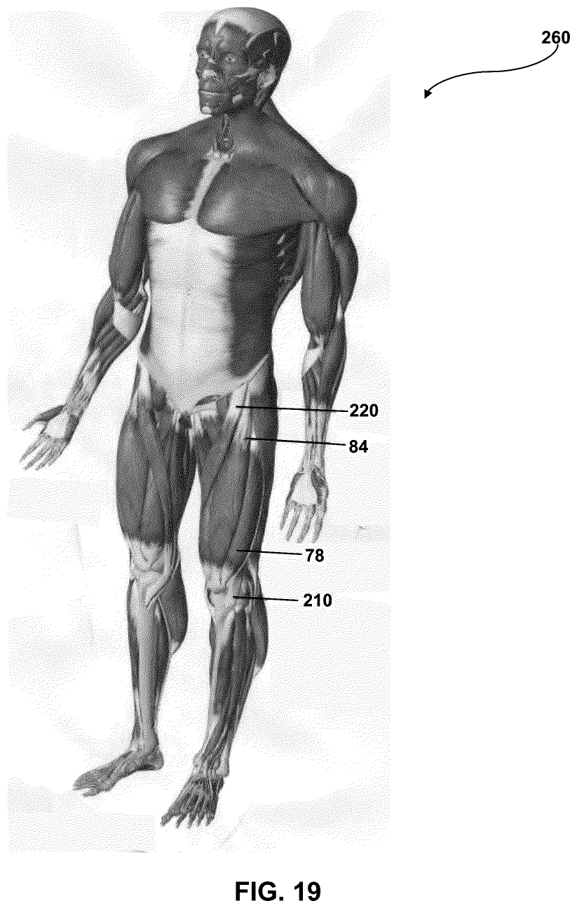

Alternatively, if the patient has knee osteoarthritis, step (4) may comprise:
performing deep tissue massage on the first group of muscles associated with the osteoarthritic knee joint, comprising:
   Vastus Lateralis 78, which is shown in FIGS. 14A and 23;
   Gluteus Maximus 120, which is shown in FIG. 15A;
   Gluteus Medius 126, which is shown in FIG. 15B;
   Semitendinosus 140, which is shown in FIG. 16A;
   Semimembranosus 144, which is shown in FIG. 16B;
   Biceps Femoris Long Head 150, which is shown in FIG. 16C;
   Gastrocnemius Medial Head 170, which is shown in FIG. 17A;
   Gastrocnemius Lateral Head 176, which is shown in FIG. 17B;
   Biceps Femoris Short Head 154, which is shown in FIG. 16D;
   Quadratus Lumborum 190, which is shown in FIG. 17C; and
   Popliteus 200, which is shown in FIG. 17D;
performing deep tissue massage on the fascia associated with the osteoarthritic knee joint, comprising:
   Iliotibial Tract 210, which is shown in FIGS. 18 and 23;
performing deep tissue massage on a second group of muscles associated with the osteoarthritic knee joint, comprising:
   Sartorius 220, which is shown in FIGS. 19, 20, and 23;
   Rectus Femoris 84, which is shown in FIGS. 14B, 19, and 23;
   Psoas Major 230, which is shown in FIGS. 21-23;
   Gracilis 240, which is shown in FIGS. 24A, 25 and 26.

Massage therapy enhances the efficacy of acupuncture and reduces the compression on the knee joint 50.

In more detail, the acupuncture of step (2) is performed at the origin or the insertion of the following muscles, shown in FIGS. 14-25.

FIG. 14 is an anterior view of the Quadriceps muscles 70. FIG. 14A shows Vastus Lateralis muscle 78, including the Vastus Lateralis Origin 80 attached to the Femur and the Vastus Lateralis Insertion 82 attached to the Patella 56. FIG. 14A also shows the insertion location and direction of three inch needle 302 at the Vastus Lateralis Origin 80 at location and direction 305A. A plurality of the needles 302 may be used depending on the patient's condition and needs.

The Vastus Lateralis 78 works with Rectus Femoris 84 to help extend the knee joint. Vastus Lateralis 78 is also active in maintaining thigh and Patella 56 position, while walking and running.

FIG. 14A illustrates insertion of a three inch needle 302, obliquely and in a top down direction, into the Vastus Lateralis Origin 80, which relaxes the Vastus Lateralis 78. Acupuncture and massage therapy relaxes Vastus Lateralis 78. A relaxed Vastus Lateralis 78 reduces the strain and tightness on the anterior side of a knee joint.

FIG. 14B shows the Rectus Femoris muscle 84, including the Rectus Femoris Origin 86, the Rectus Femoris Insertion 88, and the locations at which the Rectus Femoris muscle 84 is attached to the Ilium 106 and the patella 56.

The Rectus Femoris muscle 84 runs down the thigh. The Rectus Femoris muscle 84 acts in two ways, as it crosses over the hip and the knee joint, the Rectus Femoris muscle 84 functions to extend the knee and assist the iliopsoas in hip flexion and, as such, is a hip flexor. Massage therapy relaxes the Rectus Femoris muscle 84. A relaxed Rectus Femoris 84 reduces the strain and tightness on the anterior side of the knee joint.

FIG. 15A shows a Gluteus Maximus muscle 120, including the Gluteus Maximus Origin 122, which is attached to the Ilium 106 and Sacrum 108, and Gluteus Maximus Insertion 124, which is attached to the femur.

Acupuncture and massage therapy relaxes the Gluteus Maximus 120. A relaxed Gluteus Maximus 120 reduces the strain and tightness on the posterior side of the knee joint.

FIG. 15A shows insertion locations and directions of a plurality of needles into the Gluteus Maximus Origin 122, at locations and directions 306A, 306B, and 306C and the Gluteus Maximus Insertion 124 at locations and directions 306D and 306E.

Needle insertions into the Gluteus Maximus Origin 122 and Gluteus Maximus Insertion 124 relaxes the Gluteus Maximus 120 and muscles underneath the Gluteus Maximus 120.

The Gluteus Maximus 120 works with the Semitendinosus 140 and Semimembranosus 144 muscles to extend the hip. The Gluteus Maximus 120 also works in conjunction with the iliopsoas, piriformis, and obturator muscles to externally rotate the hip.

FIG. 15B shows a Gluteus Medius muscle 126, including the Gluteus Medius Origin 128, which is attached to the Ilium 106, and Gluteus Medius Insertion 130, which is attached to the femur. The Gluteus Medius 126 is a highly functional muscle that helps with hip movement.

FIG. 15B also shows the insertion locations and directions of a plurality of needles into the Gluteus Medius Origin 128, at locations and directions 308A, 308B, and 308C and the Gluteus Medius Insertion 130 at location and direction 308D.

In this instance, a plurality of needles selected from the needles shown in FIG. 29, are used, although other suitable needles may be used.

Three inch needles are inserted obliquely into the Gluteus Medius Origin 128. Three inch needles are also inserted into the Gluteus Medius Insertion 130, obliquely.

The needle insertions into the Gluteus Medius Origin 128 and the Gluteus Medius Insertion 130 relax the Gluteus Medius 126. The Gluteus Maximus 120 and the Gluteus Medius 126 are core muscles, which induce pressure on the knee joint. Acupuncture and massage therapy relaxes the Gluteus Medius 126. A relaxed Gluteus Medius 126 reduces the strain and tightness on the posterior side of the knee joint.

FIG. 16 shows the hamstring muscles 138, comprising the Semitendinosus 140, the Semimembranosus 144, the Biceps Femoris Long Head 150, and the Biceps Femoris Short Head 154.

FIG. 16 also shows the ischial tuberosity 139, which is where the adductor and hamstring muscles 138 of the thigh, as well as the sacrotuberous ligaments, attach.

In more detail, FIG. 16A shows the Semitendinosus muscle 140, including the Semitendinosus Origin 142, which is attached to Ilium 106, and Semitendinosus Insertion 146, which is attached to tibia.

FIG. 16A also shows the insertion locations and directions of needles at the Semitendinosus Origin 142 at location and direction 310A, and at the Semitendinosus Insertion 146 at location and direction 310B. A plurality of needles, which are shown in FIG. 29, are used, although other suitable needles may be used.

FIG. 16A shows the insertion of a three inch needle into and substantially perpendicular to the Semitendinosus Origin 142 and the insertion of a three inch needle obliquely and in a top down direction into the Semitendinosus Insertion 146.

Needle insertion into the Semitendinosus Origin 142 relaxes Semitendinosus 140, Semimembranosus 144, and Biceps Femoris Long Head 150. Needle insertion into the Semitendinosus Insertion 146 relaxes Semitendinosus 140, Sartorius 220, and Gracilis 240.

The Semitendinosus 140 extends the thigh at the hip and flexes the knee joint. Semimembranosus 144 is closest to the middle of your body. This hamstring muscles 138 flexes the knee joint, extends the thigh at the hip and offers medial rotation for the hip and lower leg. The semitendinosus muscle 140, in particular, has the added functionality of assisting the Popliteus 200 muscle in rotating the leg 73 internally.

Acupuncture and massage therapy relaxes the Semitendinosus 140. A relaxed Semitendinosus 140 reduces the strain and tightness on the posterior side of the knee joint.

FIG. 16B shows a Semimembranosus muscle 144, including the Semimembranosus Origin 148 attached to the Ilium 106 and Semimembranosus Insertion 149 attached to the tibia. The primary function of the Semimembranosus 144 is flexion of the knee joint.

With the knee semi-flexed, the Semimembranosus 144 functions as a medial rotator of the lower leg on the knee. With the hip extended, the semi-hamstrings are lateral rotators of the thigh.

FIG. 16B shows the insertion location and direction of a needle into the Semimembranosus Insertion 149 at location and direction 312A. A plurality of needles selected from the needles shown in FIG. 29 may be used, although other suitable needles may be used. FIG. 16B shows the insertion of one inch needle 304 substantially perpendicular to and into the Semimembranosus Insertion 149. Needle insertion into the Semimembranosus Insertion 149 relaxes the Semimembranosus 144.

Acupuncture and massage therapy relaxes the Semimembranosus 144. A relaxed Semimembranosus 144 reduces the strain and tightness on the posterior side of the knee joint.

FIG. 16C shows the Biceps Femoris Long Head 150, including the Biceps Femoris Long Head Origin 156, which is attached to the Ilium 106, and the Biceps Femoris Long Head Insertion 152, which is attached to the fibula 59.

The Biceps Femoris Long Head 150 is responsible for movement at both the hip joint and the knee joint. At the hip, the Biceps Femoris Long Head 150 allows for thigh extension and external rotation. Whereas at the knee, the Biceps Femoris Long Head 150 allows for knee flexion and lower leg external rotation.

FIG. 16C also shows the insertion location and direction of a needle obliquely and in a top down direction into the Biceps Femoris Long Head Insertion 152 at location and direction 314A. One or more needles 304, which are shown in FIG. 29, may be used, although other suitable needles may be used. Needle insertion into the Biceps Femoris Long Head Insertion 152 relaxes the Biceps Femoris Long Head 150 and the Biceps Femoris Short Head 154, which is shown in FIG. 17D.

Acupuncture and massage therapy relaxes the Biceps Femoris Long Head 150. A relaxed Biceps Femoris Long Head 150 reduces the strain and the tightness on the posterior side the knee joint.

FIG. 16D shows a Biceps Femoris Short Head 154, including the Biceps Femoris Short Head Origin 158, which is attached to the femur, and Biceps Femoris Short Head Insertion 160, which is attached to the fibula 59.

FIG. 16D also shows the insertion locations and directions of needles into the Biceps Femoris Short Head Origin 158 and Biceps Femoris Short Head Insertion 160, at locations and directions 316A and 316B, respectively. Three inch needles 302, shown in FIG. 29, may be used, or other suitable needles may be used.

The Biceps Femoris Short Head 154 helps flexion at the knee joint. The needle insertion into the Biceps Femoris Short Head Origin 158 relaxes the Biceps Femoris Short Head 154.

Acupuncture and massage therapy relaxes the Biceps Femoris Short Head 154. A relaxed Biceps Femoris Short Head 154 reduces the strain and the tightness on the lateral side of the knee joint.

FIG. 17 is a posterior view of Calf muscles 115 of the human body, showing a Gastrocnemius Medial Head 170 and a Gastrocnemius Lateral Head 176.

FIG. 17A shows the Gastrocnemius Medial Head 170, including the Gastrocnemius Medial Head Origin 172, which is attached to the femur, and Gastrocnemius Medial Head Insertion 174, which is attached to the tibia.

FIG. 17A also shows the insertion location and direction of a needle into the Gastrocnemius Medial Head Origin 172 at location and direction 318A. One or more of the needles 304, which are shown in FIG. 29, may be used, although other suitable needles may be used.

The Gastrocnemius Medial Head 170 is a powerful knee flexor. The needle inserted into the Gastrocnemius Medial Head Origin 172 relaxes the Gastrocnemius Medial Head 170. Acupuncture and massage therapy relaxes the Gastrocnemius Medial Head 170. A relaxed Gastrocnemius Medial Head 170 reduces the strain and tightness on the posterior side of the knee joint.

FIG. 17B shows a Gastrocnemius Lateral Head 176, including the Gastrocnemius Lateral Head Origin 178, which is attached to the femur, and the Gastrocnemius Lateral Head Insertion 180, which is attached to the fibula 59.

FIG. 17B shows the insertion location and direction of a needle into the Gastrocnemius Lateral Head Origin 178 at location and direction 320A. One or more needles 304, which is shown in FIG. 29, may be used, although other suitable needles may be used.

The Gastrocnemius Lateral Head 176 is a leg flexion at the knee joint. The needle insertion into the Gastrocnemius Lateral Head Origin 178 relaxes the Gastrocnemius Lateral Head 176. Acupuncture and massage therapy relaxes the Gastrocnemius Lateral Head 176. A relaxed Gastrocnemius Lateral Head 176 reduces the strain and tightness on the posterior side of the knee joint.

FIG. 17C shows the quadratus lumborum muscle anatomy 188, lumbar spine 114, a Quadratus Lumborum muscle 190, including the Quadratus Lumborum Origin 192, which is attached to the Ilium 106, and the Quadratus Lumborum Insertion 194, which is attached to the twelfth rib 110 and Lumbar Spine 114.

FIG. 17C shows the insertion locations and directions of a plurality of needles into the Quadratus Lumborum Insertion 194 at locations and directions 322A, 322B, 322C, and 322D, and a needle into the Quadratus Lumborum Origin 192 at location and direction 322E. A plurality of needles 302, one of which is shown in FIG. 29, may be used, although other suitable needles may be used.

The Quadratus Lumborum 190 is an extensor of the lumbar spine, a stabilizer of the lumbar area, capable of pelvic tilting laterally and capable of acting as an inspiratory accessory muscle.

A strained and tight Quadratus Lumborum 190 induces pressure on the Lumber Spine 114 and the Ilium 106, which in turn induces pressure on the Psoas Major 230, the Gluteus Maximus 120, and the Gluteus Medius 126.

Needle insertion into the Quadratus Lumborum Origin 192 and the needle insertions into the Quadratus Lumborum Insertion 194 relaxes the Quadratus Lumborum 190 and muscles on top of Quadratus Lumborum 190.

Acupuncture and massage therapy relaxes the Quadratus Lumborum 190. A relaxed Quadratus Lumborum 190 reduces stress and strain on the Psoas Major 230, the Gluteus Maximus 120, and the Gluteus Medius 126.

FIG. 17D shows a Popliteus muscle 200, including Popliteus Origin 202, which is attached to the femur, and Popliteus Insertion 204, which is attached to the tibia.

FIG. 17D also shows the insertion location and direction of a needle into the Popliteus Insertion 204 at location and direction 324A. One or more needles, such as the needle 304, which is shown in FIG. 29, may be used, although other suitable needles may be used.

The Popliteus 200 is a major stabilizer of the knee. A needle inserted into the Popliteus Insertion 204 relaxes the Popliteus 200. Acupuncture and massage therapy relaxes the Popliteus 200. A relaxed Popliteus muscle 200 reduces the strain and tightness on the posterior side of the knee joint.

FIG. 18 shows a portion of a human leg 73, showing an Iliotibial Tract fascia 210, comprising a fascia, which is a sheath of fibrous connective tissue at the lateral thigh.

FIG. 18 shows the Iliotibial Tract fascia 210, including the Iliotibial Tract Insertion 212 which is attached to the tibia, and the insertion location and direction of a needle into the Iliotibial Tract Insertion 212 at location and direction 326A. One or more needles, such as the needle 304, which is shown in FIG. 29, may be used, although other suitable needles may be used.

The Iliotibial Tract fascia 210 helps with pelvic stabilization, knee joint control, and posture control. The needle inserted into the Iliotibial Tract Insertion 212 relaxes the Iliotibial Tract fascia 210.

Acupuncture and massage therapy relaxes the Iliotibial Tract fascia 210. A relaxed Iliotibial Tract fascia 210 reduces the strain and tightness on the anterior side of the knee joint.

Again, the massage therapy of step (4) is performed on the first group of muscles and a second group of muscles associated with the osteoarthritic knee joint, the second group of muscles, which is shown in FIGS. 19-26, comprising:
Sartorius 220, which is shown in FIGS. 19, 20, and 23;
Rectus Femoris 84, which is shown in FIGS. 19 and 14B;
Psoas Major 230, which is shown in FIGS. 21-23;
Gracilis 240, which is shown in FIGS. 24A, 25 and 26.

FIG. 19 shows a human body muscular system 260, including the Sartorius muscle 220, the Rectus Femoris muscle 84, the Vastus Lateralis muscle 78, and the Iliotibial Tract fascia 210.

The Rectus Femoris muscle 84 and the Vastus Lateralis muscle 78 aid in leg lifting movement through muscle contraction. The Sartorius muscle 220 and the Iliotibial Tract fascia 210 aid in movement of the leg 73, including leg lifting and bending of the knee joint.

FIG. 20 shows the Sartorius muscle 220, including the Sartoris Origin 222, which is attached to the Ilium 106.

The Sartoris muscle 220, which is the longest muscle in the human body, has several functions, including flexion of the hip, external rotation of the hip, abduction of the hip, flexion of the knee, and internal rotation of the knee.

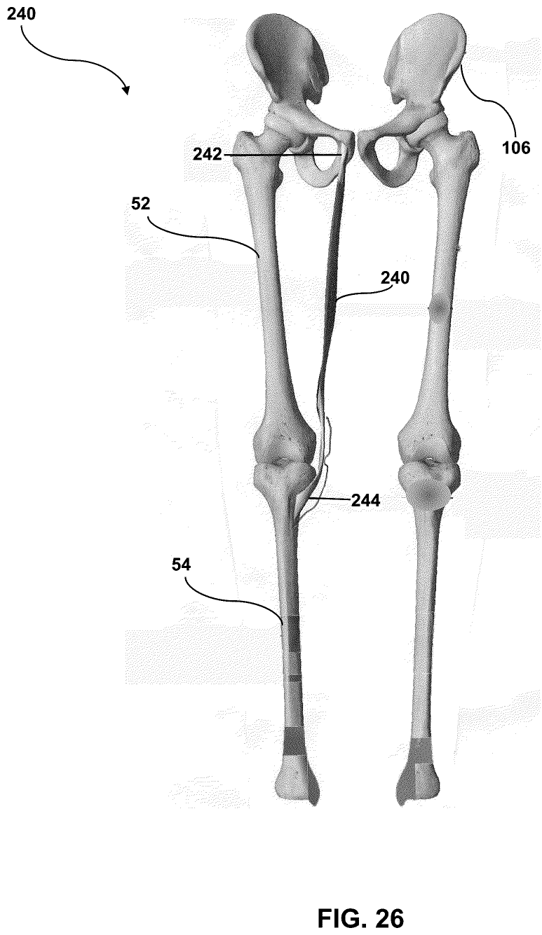

The Sartoris muscle 220 plays an important role in stabilization of the pelvis. Sartorius Insertion 224 shares the attachment location of the Semitendinosus Insertion 146 and Gracilis Insertion 244, shown in FIG. 26.

Massage therapy relaxes the Sartorius muscle 220. A relaxed Sartorius muscle 220 reduces the strain and tightness on the anterior side of the knee joint.

FIG. 21 shows the human body skeletal system 262, the Lumber Spine 114, the Ilium 106, the femur, the tibia, the fibula 59, the patella 56, the knee joint, and the deep muscle Psoas Major 230.

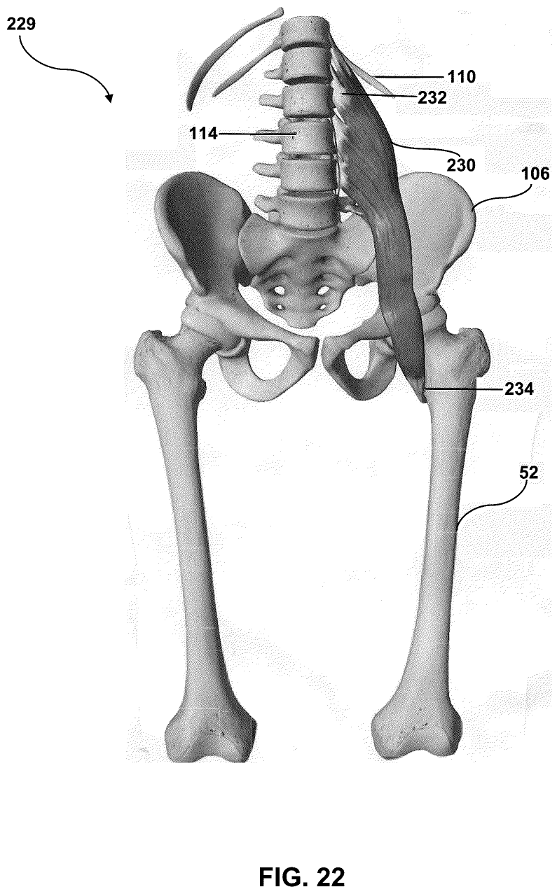

FIG. 22 shows Psoas Major muscle anatomy 229, comprising the Psoas Major muscle 230, including Psoas Major Origin 232, which is attached to the Lumber Spine 114, and Psoas Major Insertion 234, which is attached to the femur.

The Psoas Major muscle 230 functions to connect the upper body to the lower body, the outside to the inside, the appendicular to the axial skeleton, and the front to the back, with its fascial relationship.

The Psoas Major muscle 230 is a major contributor to flexion of the hip joint. A strained and tight Psoas Major muscle 230 causes stress and strain on the anterior torso and legs 73, which in turn affects all the muscles of the torso and the legs 73.

Massage therapy performed on the Psoas Major Origin 232 and the Psoas Major insertion 234 relaxes the Psoas Major muscle 230, which in turn relaxes the leg 73 and the knee joint.

FIGS. 23, 24A, 25, and 26 show the Gracilis muscle 240.

FIG. 23 shows the thigh muscles 66, including the Gracilis muscle 240.

FIGS. 24A and 24B show Hip Adductor muscle anatomy 250 of the human body, comprising the Gracilis muscle 240, Pectineus 237, Adductor Brevis 238, Adductor Longus 239, and Adductor Magnus 241.

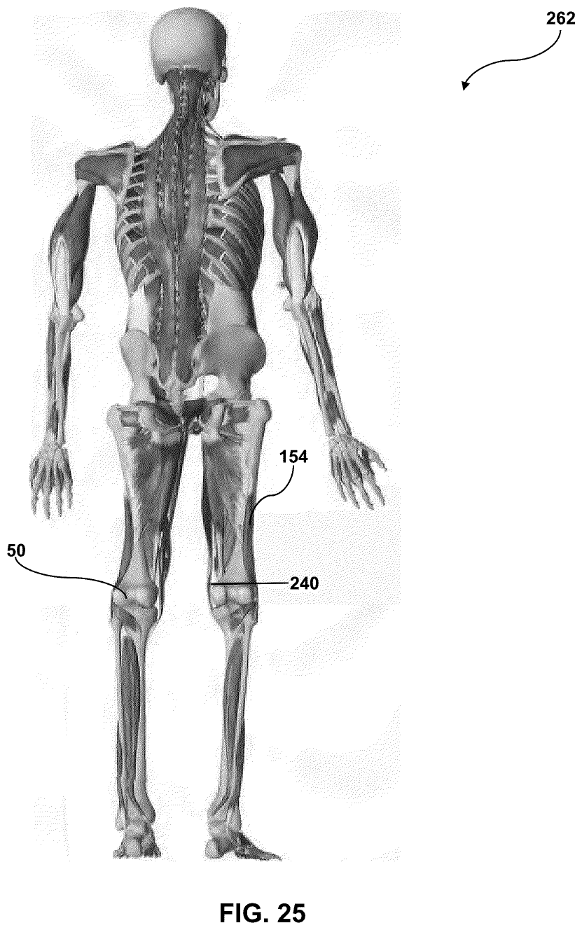

FIG. 25 shows the human body skeletal system 262, and also shows the Gracilis muscle 240 of the muscular system 260, which helps with flexion of the knee joint 50, and the Biceps Femoris Short Head 154.

FIG. 26 shows the Gracilis muscle 240, which includes Gracilis Origin 242, which is attached to the Ilium 106, and Gracilis Insertion 244, which is attached to the tibia.

The Gracilis muscle 240 functions to flex the knee, adduct the thigh 71, and medially rotate the tibia 54.

Massage therapy relaxes the Gracilis muscle 240. A relaxed Gracilis 240 reduces strain and tightness on the medial side of the knee joint.

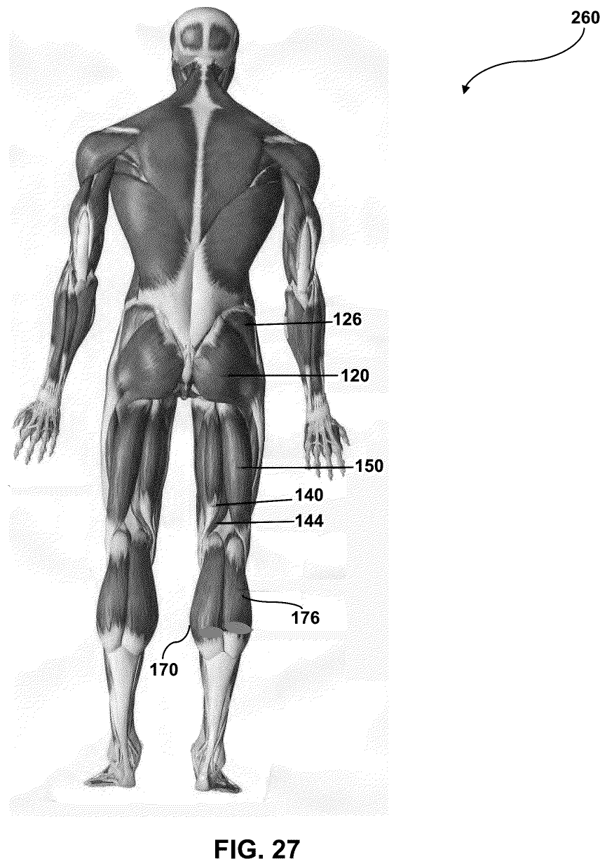

FIG. 27 shows the human body muscular system 260, showing a number of muscles that have already been discussed, which have been included for additional detail.

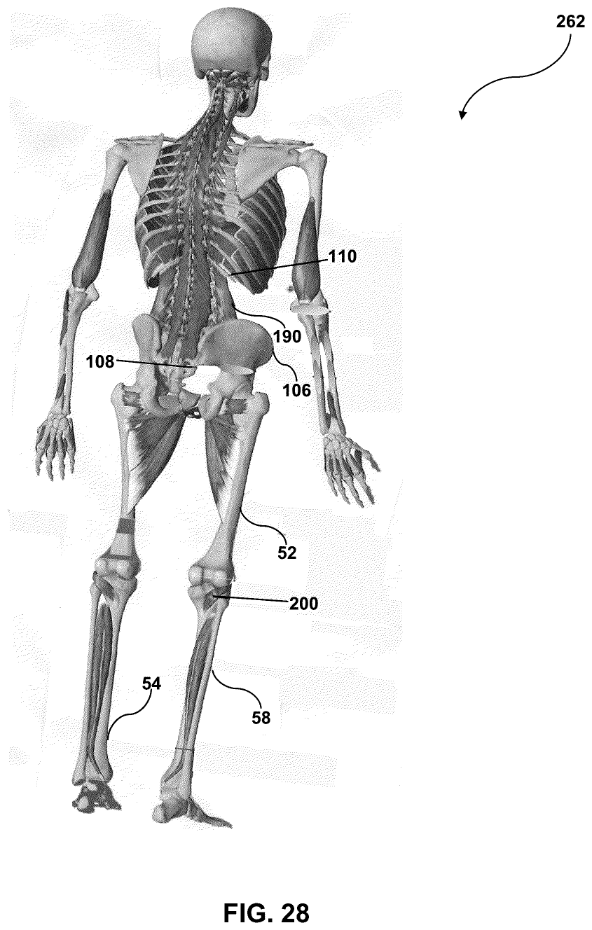

FIG. 28 shows the human body skeletal system 262, showing a number of muscles that have already been discussed, which have been included for additional detail.

FIG. 29 shows the acupuncture needles used to perform the acupuncture of step (2).

Again, the acupuncture of step (2) is performed using acupuncture needles 300, 302, and 304, which are shown in FIG. 29, and selected based upon the patient's body size and needling locations.

One or more sizes of the acupuncture needles 300, 302, and 304 or other suitable sizes and types of acupuncture needles may be inserted into the origin and/or the insertion of the above referenced muscles in an oblique direction or a perpendicular direction to the muscles to provide efficacy and minimize danger to the patient.

The patient is typically positioned in a prone position, and the acupuncture needles 300, 302, and/or 304 are typically applied on the same side of the osteoarthritic knee joint 50.

Acupuncture needles come in different lengths and gauges, which are measurements of their width and length.

The acupuncture needles 300, 302, and 304, shown in FIG. 29, are: 30 gauge ×6.0 inches; 30 gauge ×3.0 inches; and 30 gauge ×1.0 inch, respectively.

Again, the sizes of the acupuncture needles are selected, based upon the patient's body size and the acupuncture needling locations. Three inch along needles 302 and one inch long needles 304 are typically used; although, other suitable acupuncture needle sizes and types may be used.

Now, continuing with FIG. 1, if the patient has walking pain after the acupuncture treatment of step (2) and the deep tissue massage of step (4), then step (6) is performed by injecting hyaluronic acid into the knee joint.

Hyaluronic acid is a natural substance found in the human body that acts as a cushion and lubricant in the joints and other tissues. In step (6), hyaluronic acid is injected into the knee joint in conjunction with the acupuncture treatment of step (2) and the deep tissue massage of step (4) on a periodic basis, in order to promote healing, reduce osteoarthritis symptoms, and reduce walking pain at least on a temporary basis and allow the synovial membrane 104 to heal and produce an adequate amount of synovial fluid 102.

In step (6), hyaluronic acid is typically injected into the knee joint once, although the hyaluronic acid may be injected into the knee joint as needed or at suitable intervals and time frames.

Although the present invention has been described in considerable detail with reference to certain preferred versions thereof, other versions are possible. Therefore, the spirit and scope of the appended claims should not be limited to the description of the preferred versions contained herein.

What is claimed is:

1. A knee osteoarthritis treatment, comprising:
performing acupuncture on a first group of muscles associated with an osteoarthritic knee joint at each muscle origin or each muscle insertion of said first group of muscles, comprising:
Quadriceps muscles;
Gluteal muscles;
Hamstring muscles;
Calf muscles;
Quadratus Lumborum;
Popliteus;
performing acupuncture on fascia associated with said osteoarthritic knee joint, comprising:
Iliotibial Tract.

2. The knee osteoarthritis treatment of claim 1, wherein:
said Quadriceps muscles comprise: Vastus Lateralis;
said Gluteal muscles comprise: Gluteus Maximus, Gluteus Medius;
said Hamstring muscles comprise: Semitendinosus, Semimembranosus, Biceps Femoris Long Head, Biceps Femoris Short Head;
said Calf muscles comprise: Gastrocnemius Medial Head, Gastrocnemius Lateral Head.

3. The knee osteoarthritis treatment of claim 1, wherein:
said acupuncture is performed by inserting one or more acupuncture needles into said each muscle origin or said each muscle insertion and said fascia for a period of time and withdrawing said one or more acupuncture needles after said period of time.

4. The knee osteoarthritis treatment of claim 1, wherein:
said knee osteoarthritis treatment relieves taut muscles, muscle strain, muscle tightness, and undue pressure on said osteoarthritic knee joint and knee joint capsule.

5. The knee osteoarthritis treatment of claim 4, wherein:
said knee osteoarthritis treatment facilitates and promotes said osteoarthritic knee joint and said knee joint capsule to heal naturally.

6. A knee osteoarthritis treatment, comprising:
performing acupuncture on a first group of muscles associated with an osteoarthritic knee joint at each muscle origin or each muscle insertion of said first group of muscles, comprising:
Quadriceps muscles;
Gluteal muscles;
Hamstring muscles;
Calf muscles;
Quadratus Lumborum;
Popliteus;
performing acupuncture on fascia associated with said osteoarthritic knee joint, comprising:
Iliotibial Tract;
performing deep tissue massage on said first group of muscles associated with said osteoarthritic knee joint, comprising:
said Quadriceps muscles;
said Gluteal muscles;
said Hamstring muscles;
said Calf muscles;
said Quadratus Lumborum;
said Popliteus;
performing deep tissue massage on said fascia associated with said osteoarthritic knee joint, comprising:
said Iliotibial Tract; and
performing deep tissue massage on a second group of muscles associated with said osteoarthritic knee joint, comprising:
Sartorius;
said Quadriceps muscles;
Psoas Major;
Hip Adductors.

7. The knee osteoarthritis treatment of claim 6, wherein:
said Quadriceps muscles comprise: Rectus Femoris;
said Hip Adductors comprise: Gracilis.

8. The knee osteoarthritis treatment of claim 6, wherein:
said acupuncture is performed by inserting one or more acupuncture needles into said each muscle origin or said each muscle insertion and said fascia for a period of time and withdrawing said one or more acupuncture needles after said period of time.

9. The knee osteoarthritis treatment of claim 6, wherein:
said knee osteoarthritis treatment relieves taut muscles, muscle strain, muscle tightness, and undue pressure on said osteoarthritic knee joint and knee joint capsule.

10. The knee osteoarthritis treatment of claim 9, wherein:
said knee osteoarthritis treatment facilitates and promotes said osteoarthritic knee joint and said knee joint capsule to heal naturally.

11. A knee osteoarthritis treatment, comprising:
performing acupuncture on a first group of muscles associated with an osteoarthritic knee joint at each muscle origin or each muscle insertion of said first group of muscles, comprising:
Quadriceps muscles;
Gluteal muscles;
Hamstring muscles;
Calf muscles;
Quadratus Lumborum;
Popliteus;
performing acupuncture on fascia associated with said osteoarthritic knee joint, comprising:
Iliotibial Tract;
performing deep tissue massage on said first group of muscles associated with said osteoarthritic knee joint, comprising:
said Quadriceps muscles;
said Gluteal muscles;
said Hamstring muscles;
said Calf muscles;
said Quadratus Lumborum;
said Popliteus;
performing deep tissue massage on said fascia associated with said osteoarthritic knee joint, comprising:
said Iliotibial Tract; and
performing deep tissue massage on a second group of muscles associated with said osteoarthritic knee joint, comprising:
Sartorius;
said Quadriceps muscles;
Psoas Major;
Hip Adductors;
injecting hyaluronic acid into said osteoarthritic knee joint.

12. The knee osteoarthritis treatment of claim 11, wherein:
said Quadriceps muscles comprise: Rectus Femoris;
said Hip Adductors comprise: Gracilis.

13. The knee osteoarthritis treatment of claim 11, wherein:
said acupuncture is performed by inserting one or more acupuncture needles into said each muscle origin or said each muscle insertion and said fascia for a period of time and withdrawing said one or more acupuncture needles after said period of time.

14. The knee osteoarthritis treatment of claim 11, wherein:
said knee osteoarthritis treatment relieves taut muscles, muscle strain, muscle tightness, and undue pressure on said osteoarthritic knee joint and knee joint capsule.

15. The knee osteoarthritis treatment of claim 14, wherein:
said knee osteoarthritis treatment facilitates and promotes said osteoarthritic knee joint and said knee joint capsule to heal naturally.

16. A knee osteoarthritis treatment, comprising:
performing acupuncture on a first group of muscles associated with an osteoarthritic knee joint at each muscle origin or each muscle insertion of each muscle of said first group of muscles, comprising:
Vastus Lateralis;
Gluteus Maximus;
Gluteus Medius;
Semitendinosus;
Semimembranosus;
Biceps Femoris Long Head;
Gastrocnemius Medial Head;
Gastrocnemius Lateral Head;
Biceps Femoris Short Head;
Quadratus Lumborum;
Popliteus;
performing acupuncture on fascia associated with said osteoarthritic knee joint, comprising:
Iliotibial Tract.

17. The knee osteoarthritis treatment of claim 16, wherein:
said acupuncture is performed by inserting one or more acupuncture needles into said each muscle origin or said each muscle insertion and said fascia for a period of time and withdrawing said one or more acupuncture needles after said period of time.

18. The knee osteoarthritis treatment of claim 16, wherein:
said knee osteoarthritis treatment relieves taut muscles, muscle strain, muscle tightness, and undue pressure on said osteoarthritic knee joint and knee joint capsule.

19. The knee osteoarthritis treatment of claim 18, wherein:
said knee osteoarthritis treatment facilitates and promotes said osteoarthritic knee joint and said knee joint capsule to heal naturally.

20. A knee osteoarthritis treatment, comprising:
performing acupuncture on a first group of muscles associated with an osteoarthritic knee joint at each muscle origin or each muscle insertion of each muscle of said first group of muscles, comprising:
Vastus Lateralis;
Gluteus Maximus;
Gluteus Medius;
Semitendinosus;
Semimembranosus;
Biceps Femoris Long Head;
Gastrocnemius Medial Head;
Gastrocnemius Lateral Head;
Biceps Femoris Short Head;
Quadratus Lumborum;
Popliteus;
performing acupuncture on fascia associated with said osteoarthritic knee joint, comprising:
Iliotibial Tract;
performing deep tissue massage on said first group of muscles associated with said osteoarthritic knee joint, comprising:
said Vastus Lateralis;
said Gluteus Maximus;
said Gluteus Medius;
said Semitendinosus;
said Semimembranosus;
said Biceps Femoris Long Head;
said Gastrocnemius Medial Head;
said Gastrocnemius Lateral Head;
said Biceps Femoris Short Head;
said Quadratus Lumborum;
said Popliteus; and
performing deep tissue massage on said fascia associated with said osteoarthritic knee joint, comprising:
said Iliotibial Tract;
performing deep tissue massage on a second group of muscles associated with said osteoarthritic knee joint, comprising:
Sartorius;
Rectus Femoris;
Psoas Major;
Gracilis.

21. The knee osteoarthritis treatment of claim 20, wherein:
said acupuncture is performed by inserting one or more acupuncture needles into said each muscle origin or said each muscle insertion and said fascia for a period of time and withdrawing said one or more acupuncture needles after said period of time.

22. The knee osteoarthritis treatment of claim 20, wherein:
said knee osteoarthritis treatment relieves taut muscles, muscle strain, muscle tightness, and undue pressure on said osteoarthritic knee joint and knee joint capsule.

23. The knee osteoarthritis treatment of claim 22, wherein:
said knee osteoarthritis treatment facilitates and promotes said osteoarthritic knee joint and said knee joint capsule to heal naturally.

24. A knee osteoarthritis treatment, comprising:
performing acupuncture on a first group of muscles associated with an osteoarthritic knee joint at each muscle origin or each muscle insertion of each muscle of said first group of muscles, comprising:
Vastus Lateralis;
Gluteus Maximus;
Gluteus Medius;
Semitendinosus;
Semimembranosus;
Biceps Femoris Long Head;
Gastrocnemius Medial Head;
Gastrocnemius Lateral Head;
Biceps Femoris Short Head;
Quadratus Lumborum;
Popliteus;
performing acupuncture on fascia associated with said osteoarthritic knee joint, comprising:
Iliotibial Tract;
performing deep tissue massage on said first group of muscles associated with said osteoarthritic knee joint, comprising:
said Vastus Lateralis;
said Gluteus Maximus;
said Gluteus Medius;
said Semitendinosus;
said Semimembranosus;
said Biceps Femoris Long Head;
said Gastrocnemius Medial Head;
said Gastrocnemius Lateral Head;
said Biceps Femoris Short Head;
said Quadratus Lumborum;
said Popliteus; and
performing deep tissue massage on said fascia associated with said osteoarthritic knee joint, comprising:
said Iliotibial Tract;
performing deep tissue massage on a second group of muscles associated with said osteoarthritic knee joint, comprising:
Sartorius;
Rectus Femoris;
Psoas Major;
Gracilis;
injecting hyaluronic acid into said osteoarthritic knee joint.

25. The knee osteoarthritis treatment of claim 24, wherein:
said acupuncture is performed by inserting one or more acupuncture needles into said each muscle origin or said each muscle insertion and said fascia for a period of time and withdrawing said one or more acupuncture needles after said period of time.

26. The knee osteoarthritis treatment of claim 24, wherein:
said knee osteoarthritis treatment relieves taut muscles, muscle strain, muscle tightness, and undue pressure on said osteoarthritic knee joint and knee joint capsule.

27. The knee osteoarthritis treatment of claim 26, wherein:
said knee osteoarthritis treatment facilitates and promotes said osteoarthritic knee joint and said knee joint capsule to heal naturally.
